(19) United States
(12) Patent Application Publication
(10) Pub. No.: US 2026/0049431 A1
(43) Pub. Date: Feb. 19, 2026

(54) LAUNDRY MACHINE

(71) Applicant: LG ELECTRONICS INC., Seoul (KR)

(72) Inventors: Sunghwan BAE, Seoul (KR); Jihun KIM, Seoul (KR); Mingyu KIM, Seoul (KR)

(21) Appl. No.: 19/240,315

(22) Filed: Jun. 17, 2025

(30) Foreign Application Priority Data
Aug. 19, 2024 (KR) 10-2024-0110337

(51) Int. Cl. D06F 39/02; B01F 23/40; B01F 23/43; B01F 27/07; B01F 27/113; B01F 27/91; B01F 101/00; D06F 23/04; D06F 39/08

(52) U.S. Cl. CPC D06F 39/02; B01F 23/43; B01F 23/483; B01F 27/07; B01F 27/113; B01F 27/91; D06F 23/04; D06F 39/088; B01F 2101/4505

(57) ABSTRACT

The washing machine according to an embodiment of the present invention comprises: a cabinet; a tub rotatably disposed within the cabinet; and a detergent supply device provided in the cabinet for supplying detergent to the tub, wherein the detergent supply device comprises: a housing fixedly mounted to the cabinet and connected to a water supply device; a drawer withdrawbly mounted to the housing, and including a receiving portion recessed to accommodate detergent and a rotating boss extending upward from a bottom of the receiving portion; a mixing member rotatably disposed in the receiving portion to mix the detergent inside the receiving portion; and a flow path member that is connected to the housing at a position above the drawer and forms a flow path for supplying washing water from the water supply device to the drawer, wherein the mixing member includes: a rotation axis with a diameter that increases toward the bottom, into which the rotating boss is inserted; and a plurality of blades extending radially from an outer surface of the rotation axis.

### CROSS-REFERENCE TO RELATED APPLICATIONS

The present application claims the benefits of priority to Korean Patent Application No. 10-2024-0110337, filed on Aug. 19, 2024, of which its incorporated herein by reference in its entirety.

### THE BACKGROUND

### 1. The Field

The present invention is related to a laundry machine.

### 2. Description of the Related Art

Generally, a laundry machine is a home appliance that performs washing operations by appropriately mixing detergent and washing water after the user puts laundry into the washing tub and enters the operation command.

Recent laundry machines are equipped with a detergent supply device that can use both solid and liquid detergents, and the detergent and washing water are supplied together into the washing tub according to the supply of washing water.

However, when powdered or solid detergent is loaded into the detergent supply device, if the temperature of the incoming washing water is low, the detergent may not dissolve properly and be supplied to the drum in clumps.

To address this issue, a laundry machine is being developed that includes a fan-shaped mixing member in the detergent supply device to dissolve powdered or solid detergent, and a structure where water is sprayed toward the mixing member to force it to rotate.

Korean Patent Publication No. 10-2022-0099876 (Jul. 14, 2022) discloses a washing machine equipped with a rotating member inside a detergent container. In particular, it discloses a structure in which the coupling portion of the agitation device is rotatably fitted into a siphon tube protruding from the bottom of the detergent container.

When washing water is supplied into the detergent container, the mixing device may float due to buoyancy, causing a problem that the coupling portion of the mixing device is separated from the siphon tube. If the agitator is separated from the siphon tube, it may collide with the inner wall of the detergent container due to the washing water sprayed into the detergent container, causing noise and potentially damaging the agitator blades. Additionally, this may result in inadequate mixing of detergent and washing water.

### THE SUMMARY

The present invention is proposed to improve the above-mentioned problems.

The washing machine according to an embodiment of the present invention for achieving the above-mentioned purpose comprises: a cabinet; a tub rotatably disposed within the cabinet; and a detergent supply device provided in the cabinet for supplying detergent to the tub, wherein the detergent supply device comprises: a housing fixedly mounted to the cabinet and connected to a water supply device; a drawer withdrawably mounted to the housing, and including a receiving portion recessed to accommodate detergent and a rotating boss extending upward from a bottom of the receiving portion; a mixing member rotatably disposed in the receiving portion to mix the detergent inside the receiving portion; and a flow path member that is connected to the housing at a position above the drawer and forms a flow path for supplying washing water from the water supply device to the drawer, wherein the mixing member includes: a rotation axis with a diameter that increases toward the bottom, into which the rotating boss is inserted; and a plurality of blades extending radially from an outer surface of the rotation axis.

The mixing member further includes an axis support member extending from an inner upper end of the rotation axis, and wherein the axis support member is placed on an upper surface of the rotating boss.

The axis support member includes: a support protrusion extending downward from the inner upper end of the rotation axis for a predetermined length; and a plurality of support bases extending in a rib shape from an outer surface of the support protrusion.

A lower end of each of the plurality of support bases extends to a point spaced upward from a lower end of the support protrusion.

An end of the support protrusion is formed to be pointed, and wherein the upper surface of the rotating boss includes a recessed portion where the end of the support protrusion is seated.

A diameter of the rotating boss is constant or increases toward the lower end.

An inner diameter of the rotation axis decreases toward the upper end.

The rotation axis includes: a first portion of which an inner diameter decreases linearly from the bottom toward the top; and a second portion formed at an upper end of the first portion, and having a longitudinal section that forms a parabolic shape.

The upper surface of the rotating boss is coplanar with a horizontal plane passing through the point where the first portion and the second portion meet.

A drainage groove is formed on a bottom of the receiving portion corresponding to an edge of the rotating boss, and wherein a lower end of the rotation axis is positioned in the drainage groove and spaced apart from a bottom of the drainage groove.

The mixing member further includes a ring connecting lower ends of the radial ends of the plurality of blades.

The mixing member further includes auxiliary wings connecting the radial ends of each blade to an upper surface of the ring.

The auxiliary wing has a predetermined height and extends along the ring for a predetermined length.

Side edges of the blades and the auxiliary wings are formed to incline in the rotational direction of the blades from the bottom to the top.

At least one of the corner where the upper end of the auxiliary blade and the blade meet, the corner where the upper and side ends of the auxiliary blade meet, or the corner where the side end of the auxiliary blade and the ring meet is formed in a rounded shape.

The washing machine according to the proposed embodiment can be expected to have the following effects.

The washing machine according to the embodiment of the present invention is provided with a flow path member which has flow paths for supplying water, is disposed above the drawer into which powder detergent is introduced, and is connected to the housing to complete the flow paths.

In particular, a nozzle for spraying water to rotate a mixing member for dissolving powdered detergent and shower holes for cleaning the receptacle where powdered detergent is stored are formed, thereby providing the advantage of effectively dissolving powdered detergent.

Furthermore, the nozzle and shower holes are both formed on a single flow path member, and the flow path member is connected to the housing to form flow paths. Therefore, the formation of a flow path for dissolving and cleaning powdered detergent is possible solely through the connection of the housing and the flow path member, thereby simplifying the overall structure of the detergent supply device and improving productivity.

Furthermore, the nozzles formed on the flow member spray water in a direction crossing the blade surface of the mixing member and sprays water at an angle downward, thereby effectively enabling the rotation of the mixing member.

Furthermore, the water sprayed from the nozzles is sprayed at an angle toward the front and downward, preventing the dispersion of powdered detergent within the receiving portion, thereby preventing contamination of the detergent supply device and maintaining a clean state.

In addition, by forming a ring connecting the lower end of the blade, an acute angled sharp lower edge of the blade is removed, thereby preventing the user from being injured.

Furthermore, since the inserted length of the rotating boss into the rotation axis is sufficiently long, the blade and the nozzle portion of the discharge path interfere with each other before the rotation axis is separated from the rotating boss, thereby preventing the mixing member from detaching from the rotating boss.

### BRIEF DESCRIPTION OF THE DRAWINGS

FIG. 1 is an isometric view of a laundry machine according to an embodiment of the present invention.

FIG. 2 is a rear view of the laundry machine.

FIG. 3 is an isometric view of the upper frame showing the detergent supply device being pulled out.

FIG. 4 is a plan view of the detergent supply device.

FIG. 5 is an isometric view of the detergent supply device.

FIG. 6 is an exploded perspective view of the drawer separated from the housing of the detergent supply device as seen from the front.

FIG. 7 is an exploded perspective view showing the rear of the drawer when the drawer is separated from the housing.

FIG. 8 is an exploded perspective view of the detergent supply device.

FIG. 9 is a perspective view of the housing with the flow path member attached, viewed from the front lower side.

FIG. 10 is an exploded perspective view of the housing and flow path member, viewed from the top.

FIG. 11 is an exploded perspective view of the housing and flow path member, viewed from the bottom.

FIG. 12 is a plan view of the flow path member.

FIG. 13 is an isometric view of the flow path member as seen from above.

FIG. 14 is an isometric view of the flow path member as seen from the rear.

FIG. 15 is an isometric view of the flow path member as seen from below.

FIG. 16 is a sectional isometric view of FIG. 5 along line 16-16.

FIG. 17 is an exploded perspective view of the drawer, mixing member, and receiving portion cover separated, as viewed from above.

FIG. 18 is an exploded perspective view of the drawer, mixing member, and receiving portion cover separated, as viewed from below.

FIG. 19 is a perspective view of the mixing member.

FIG. 20 is a drawing showing the flow path of the washing water supplied by the detergent supply device.

FIG. 21 is a drawing showing the flow state of the washing water in the distribution channel of the detergent supply device.

FIG. 22 is a drawing showing the arrangement of the water supply ports connected to each receiving portion of the drawer.

FIG. 23 is a drawing showing the washing water being sprayed into the mixing member through the nozzle of the path member.

FIG. 24 is a drawing showing the washing water falling into the first receiving portion through the first shower hole of the path member.

FIG. 25 is a drawing showing washing water falling into the second receiving portion through the second shower hole formed in the flow path member.

FIG. 26 is a drawing showing washing water falling into the third receiving portion through the third shower hole of the flow path member.

FIG. 27 is a perspective view of the mixing member according to an embodiment of the present invention.

FIG. 28 is an enlarged perspective view of the rotation axis of the mixing member as viewed from below.

FIG. 29 is a cross-sectional view along the 29-29 line in FIG. 27.

FIG. 30 is a cross-sectional view showing the mixing member mounted on the rotating boss.

### DETAILED DESCRIPTION

The following describes in detail specific embodiments of the present invention with reference to the accompanying drawings. However, the present invention is not limited to the embodiments in which the ideas of the present invention are presented, and other embodiments that fall within the scope of the ideas of the present invention can be easily proposed by adding, changing, or deleting other components.

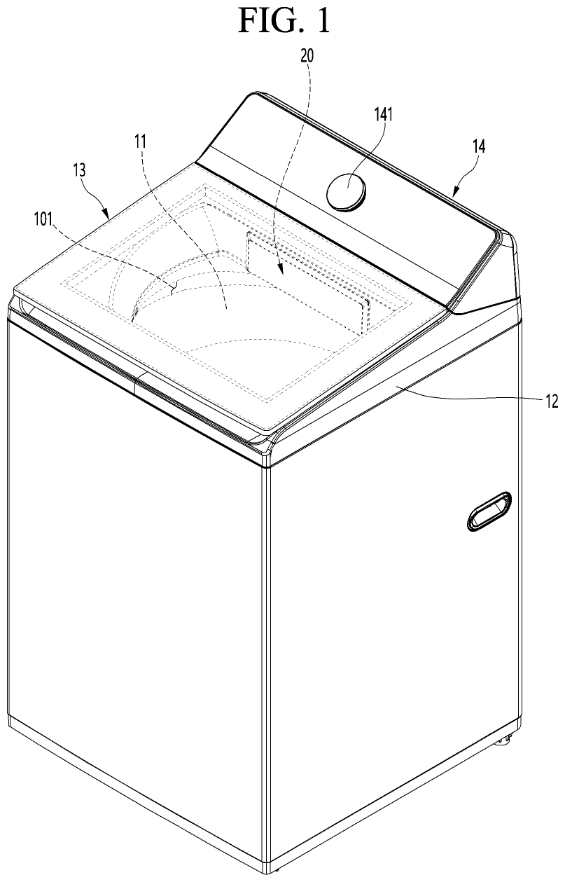

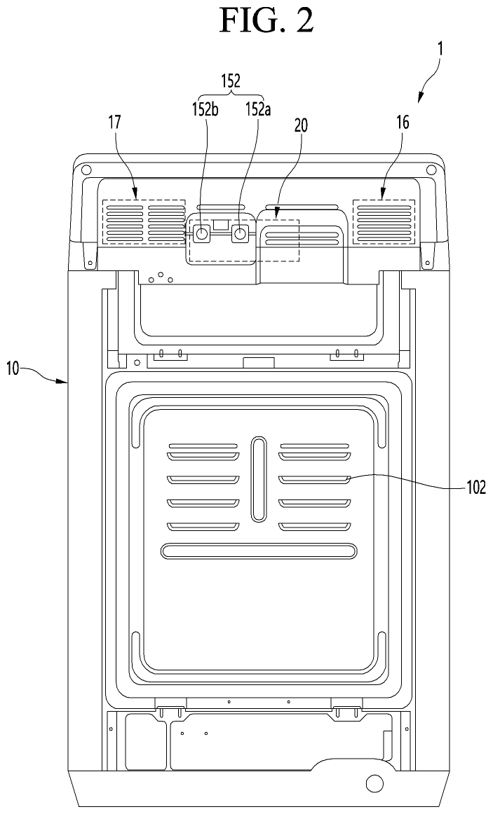

Before proceeding with the description, the directions are defined. In the embodiment of the present invention, with respect to a center point of the laundry machine shown in FIGS. 1 and 2, the direction toward the floor surface where the laundry machine is installed is defined as a downward direction; the direction toward the surface where the opening for the input port is formed in the cabinet is defined as an upward direction; the direction toward the surface where the back plate is installed is defined as a rearward direction; and the direction toward the surface opposite the rearward direction is defined as a forward direction. When referring to directions not explicitly defined, the directions can be defined and described based on each figure.

Furthermore, while the embodiment of the present invention is illustrated using an example of a top-loading type laundry machine with a door formed on the upper surface and laundry being loaded through the opened upper surface, the present invention is not limited to the structure and form of the laundry machine and is applicable to all forms of laundry machines equipped with a detergent supply device. For example, the present invention is applicable to various laundry machines, including drum laundry machines.

FIG. 1 is a perspective view of the laundry machine according to an embodiment of the present invention, and FIG. 2 is a rear view of the laundry machine.

Referring to FIGS. 1 and 2, the laundry machine 1 according to an embodiment of the present invention includes a cabinet 10, an upper frame 12 placed on the upper surface of the cabinet 10, a door 13 that is rotatably connected to the upper frame 12, and a control panel 14 mounted on the rear edge of the upper frame 12.

In detail, the cabinet 10 forms the exterior of the laundry machine 1 and can form a space for washing inside thereof.

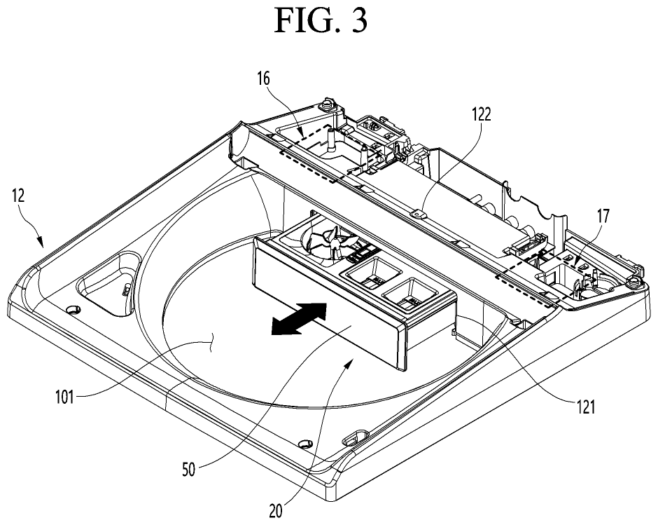

For example, the cabinet 10 may be formed in a hexahedral shape, with an open upper surface, and the upper frame 12 covers the open upper surface of the cabinet 10. Furthermore, the upper frame 12 includes an inlet 101 (See FIG. 3), and the door 13 opens and closes the inlet 101.

Furthermore, the interior of the cabinet 10 accommodates a tub 11 connected to the inlet 101. The upper surface of the tub 11 is open and communicates with the inlet 101, and the interior of the tub 11 may accommodate a washing drum for receiving laundry. The washing drum may include a cylindrical drum. Furthermore, the interior of the cabinet 10 may be equipped with a motor and other drive devices for driving the drum.

For example, the control panel 14 may be provided on the upper surface of the upper frame 12 corresponding to the rear side of the inlet 101. Furthermore, the control panel 14 may be equipped with operating members 141 for operating the laundry machine 1. For example, the operating members 141 may include a knob and buttons. Additionally, the control panel 14 may be further equipped with a display for indicating the operation of the laundry machine 1.

The rear end of the door 13 is pivotably connected to the upper frame 12, allowing the user to lift or lower the front end of the door 13 to open or close the inlet 101. Additionally, at least a portion of the door 13 may be formed to be see-through such as transparent or translucent. Therefore, the user can see the inside of the washing drum through the see-through part of the door 13.

Meanwhile, the rear of the cabinet 10 may be formed by a back cover 102. When the back cover 102 is separated or removed, the components installed inside the laundry machine 1 become accessible for maintenance. For example, when the back cover 102 is separated, the power supply device 16, the water level sensor 17, and water supply device 15 arranged on the control panel 14 can be replaced or repaired.

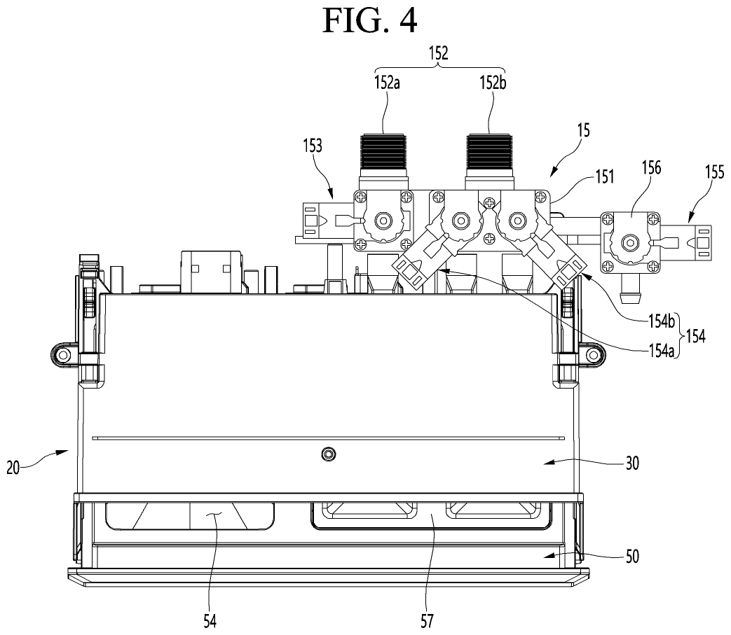

Additionally, the rear of the cabinet 10 may be equipped with a water supply pipe connection portion 152. The water supply pipe connection portion 152 may be connected to a water supply hose extending from an external water source. The water supply pipe connection portion 152 may be part of the water supply device 15 (See FIG. 4) described below. The water supply device 15 includes a plurality of valves and may be connected to a detergent supply device 20 arranged inside the cabinet 10. The water supply pipe connection portion 152 may include a hot water pipe connection portion 152a for supplying hot water and a cold water pipe connection portion 152b for supplying cold water. The water supply device 15 is described in more detail below with reference to the drawings.

The detergent supply device 20 may be provided on one side of the inlet 101, specifically on the rear side of the inlet 101. The detergent supply device 20 is configured to be withdrawable forward from the rear edge of the inlet 101, allowing the user to supply detergent into the detergent supply device 20. Furthermore, the detergent supply device 20 is connected to the water supply device 15, so that the detergent introduced into the detergent supply device 20 can be mixed with water supplied from the water supply device 15 and then supplied into the interior of the tub 11.

The following describes the detergent supply device 20 in more detail with reference to the drawings.

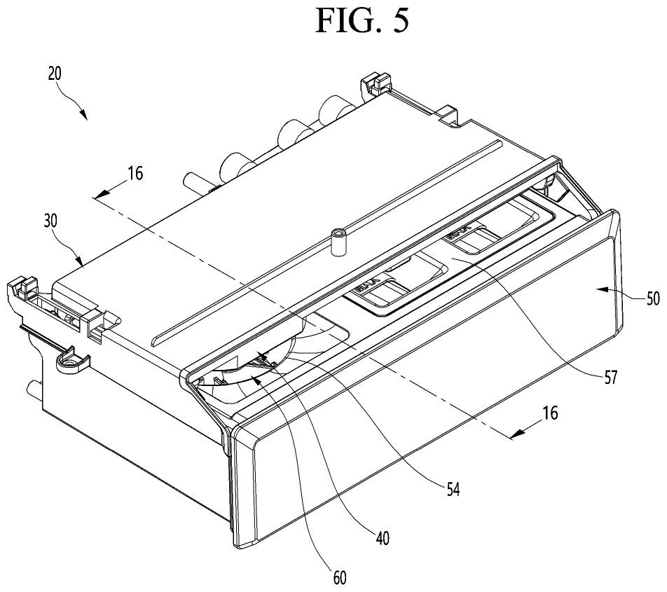

FIG. 3 is a perspective view of the upper frame showing the detergent supply device in the withdrawn state, FIG. 4 is a plan view of the detergent supply device, and FIG. 5 is a perspective view of the detergent supply device.

Referring to FIGS. 3 to 5, the upper frame 12 forming the inlet 101 is coupled to the upper surface of the cabinet 10.

In detail, the upper frame 12 forms the upper part of the laundry machine 1, and the inlet 101 can be closed by the door 13. Additionally, the control panel 14 can be arranged on the rear side of the upper surface of the upper frame 12.

Furthermore, the detergent supply device 20 may be disposed on the upper frame 12. The detergent supply device 20 may be inserted into the frame opening 121 formed on one side of the inlet 101, specifically on the rear side of the inlet 101.

Furthermore, the detergent supply device 20 is mounted inside the upper frame 12 through the frame opening 121. The detergent supply device 20 includes a housing 30 fixed inside the upper frame 12, a drawer 50 that can be pulled out and inserted into the housing 30, and a flow path member 40 that is connected to the housing 30 to form a flow path of water that is supplied to the drawer 50. Furthermore, in a state where the drawer 50 is closed, i.e., inserted into the interior of the housing 30, the front surface of the drawer 50 may form a portion of the rear surface of the inlet 101.

The detergent supply device 20 may be positioned at the lower central portion of the control panel 14. Furthermore, on the left and right edges of the control panel 14 corresponding to the left and right edges of the detergent supply device 20, a power supply device 16 for supplying power to drive the laundry machine 1 and a water level sensor 17 for detecting the water level in the tub 11 may be provided, respectively. Furthermore, a PCB may be arranged in the central portion of the control panel 14 corresponding to the upper side of the detergent supply device 20, which is electrically connected to various components including the operation unit arranged on the front of the control panel 14.

In addition, the water supply device 15 may be connected to the rear end of the detergent supply device 20. Furthermore, in a state where the detergent supply device 20 is installed, the water supply device 15 may be exposed externally from the rear of the laundry machine 1 and connected to a water supply pipe.

The water supply device 15 may be connected to the housing 30 of the detergent supply device 20. Specifically, the water supply device 15 may be positioned at a point offset to the left or right of the rear of the housing 30. For example, the water supply device 15 may be connected to a point closer to the right edge of the rear of the housing 30. The eccentric arrangement of the water supply device 15 facilitates the arrangement of wires connected to the valves 152, 153, 154 constituting the water supply device 15. Furthermore, other electrical components inside the control panel 14 can be efficiently arranged, thereby minimizing interference with the water supply device 15.

The water supply device 15 may include a water supply body 151 with a water supply pipe connection portion 152 and multiple valves 153, 154 connected to the water supply body 151. The water supply pipe connection portion 152 may include a hot water connection portion 152a and a cold water connection portion 152b that protrude rearward, as described above.

The valves may include a hot water valve 153 and a cold water valve 154. The hot water valve 153 allows hot water supplied through the hot water connection portion 152a to be selectively supplied to the detergent supply device 20. The cold water valve 154 allows cold water supplied through the cold water connection portion 152b to be selectively supplied to the detergent supply device 20.

The cold water valve 154 may include a first cold water valve 154a and a second cold water valve 154b. The first cold water valve 154a may be understood as a valve that selectively supplies cold water to either the first receiving portion 54 or the second receiving portion 55, which will be described below. The second cold water valve 154b can be understood as a valve that selectively supplies cold water to the third receiving portion 56 described below. The first cold water valve 154a and the second cold water valve 154b are arranged in a crossing manner away from each other, thereby preventing or minimizing the possibility of misconnection of wires.

Meanwhile, an additional water supply section 156 may be further formed in the water supply body 151. The additional water supply section 156 may be configured to directly spray water into the tub 11. The additional water supply section 156 may further improve the efficiency of the washing operation. The additional water supply section 156 may be further extended to the side of the detergent supply device 20. Furthermore, the additional water supply section 156 may be equipped with an additional valve 155 to open or close the flow path for directly spraying water into the tub 11.

The water supply device 15 is connected to the rear of the housing 30, and the flow path member 40 is mounted on the upper surface inside the housing 30 to form a flow path communicating with the water supply device 15. Furthermore, the flow path member 40 is positioned above the drawer 50 in the state where the drawer 50 is closed. Therefore, water can fall from above the drawer 50 through the flow path member 40, and the falling water can be mixed with the detergent introduced into the drawer 50 and supplied to the tub 11.

For example, the drawer 50 may have a receiving portion 53. Specifically, the receiving portion 53 may include a first receiving portion 54, a second receiving portion 55, and a third receiving portion 56. Furthermore, the flow path member 40 may have independent flows directed toward each of the first receiving portion 54, second receiving portion 55, and third receiving portion 56. That is, by simply mounting a single flow path member 40 on the housing 30, it is possible to provide multiple flow paths that supply water to each of the multiple receiving portions 54, 55, 56 formed in the drawer 50.

Below, with reference to the drawings, the detailed structure of the housing 30, flow path member 40, and drawer 50 constituting the water supply device 15 will be described in detail.

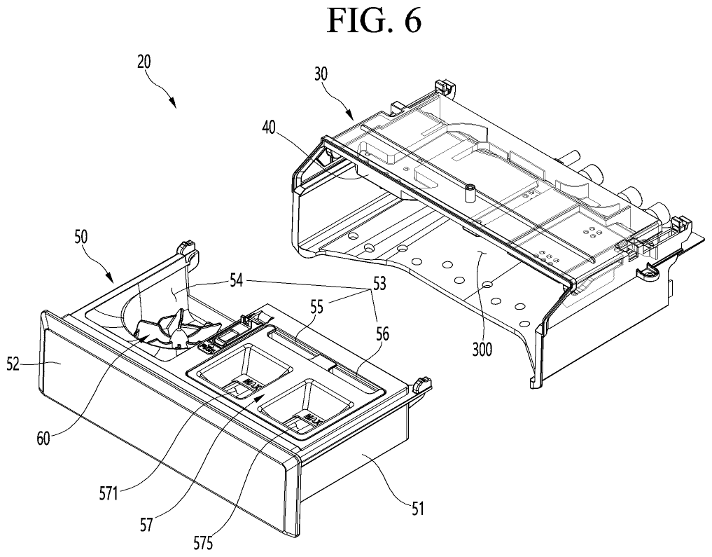

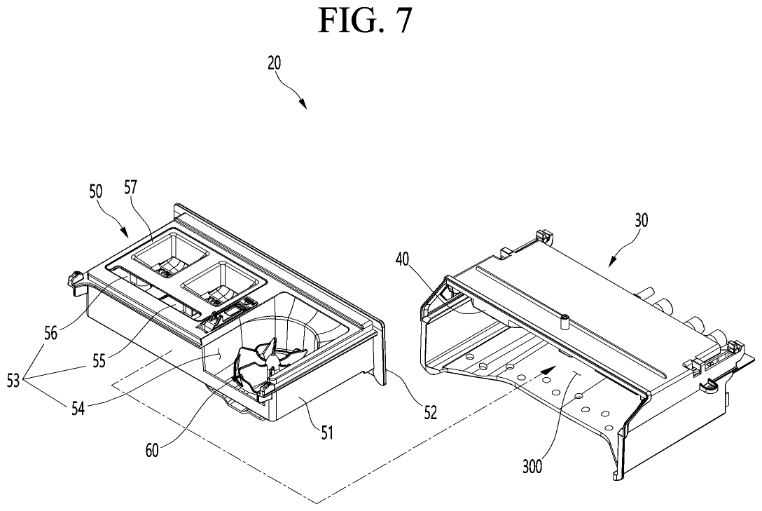

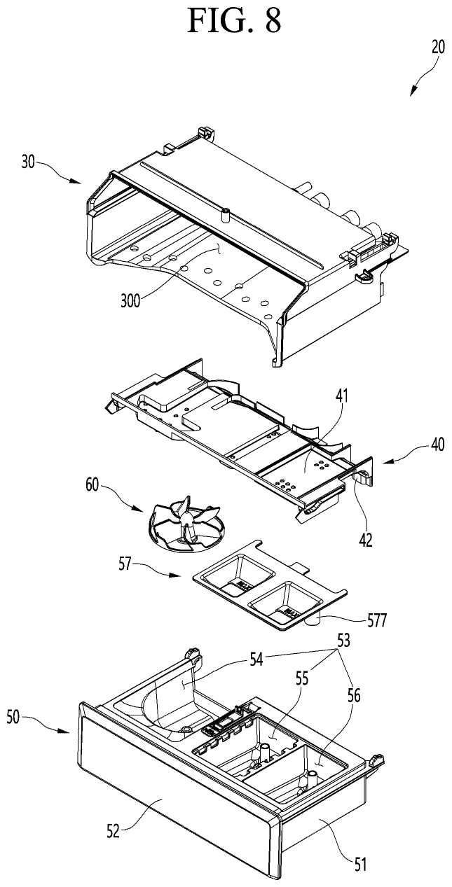

FIG. 6 is a front view of the housing of the detergent supply device with the drawer separated, FIG. 7 is a rear view of the drawer with the drawer separated from the housing, and FIG. 8 is an exploded view of the detergent supply device.

Referring to FIGS. 6 to 8, the housing 30 can be formed into a box-shaped structure with an open front, and can form a receiving space 300 that accommodates the flow path member 40 and the drawer 50 inside. For example, the housing 30 may be formed as a single piece by plastic injection molding.

The housing 30 may be connected to a water supply device 15 at the rear, and water supplied through the water supply device 15 may be supplied to the drawer 50 via the flow path member 40. For this purpose, the flow path member 40 can be coupled to the interior of the housing 30.

In detail, the flow path member 40 can be mounted on the upper surface of the interior of the housing 30. Furthermore, the flow path member 40 can have a plurality of flow passages formed with open upper surfaces. Therefore, when the flow path member 40 is mounted on the housing 30, one or more flow passages may be formed to supply water to the drawer 50 via the housing 30 and the flow path member 40. Furthermore, in a state where the flow pathepath member 40 is mounted, the one or more flow passages may communicate with the water supply device 15.

The flow path member 40 may be positioned on the upper side of the drawer 50 when mounted on the housing 30. Furthermore, the front end of the flow path member 40 may extend to the front end of the upper surface of the housing 30. Therefore, water may fall toward the drawer 50 across the entire upper surface area of the receiving space 300.

The drawer 50 may be accommodated within the receiving space 300. The drawer 50 may be arranged so that it can be pulled out and pushed in through the open front of the housing 30. The drawer 50 may form a plurality of downwardly recessed receiving portions 53. The plurality of receiving portions 53 may be filled with detergent for washing.

For example, the receiving portions 53 may include a first receiving portion 54 for powder detergent, a second receiving portion 55 for liquid detergent, and a third receiving portion 56 for fabric softener. Of course, the second receiving portion 55 or the third receiving portion 56 may be omitted as needed.

The passages formed in the flow path member 40 may be formed on the upper side corresponding to the first receiving portion 54, the second receiving portion 55, and the third receiving portion 56. Furthermore, the water supplied from the water supply device 15 may be divided and supplied independently to the first receiving portion 54, the second receiving portion 55, and the third receiving portion 56.

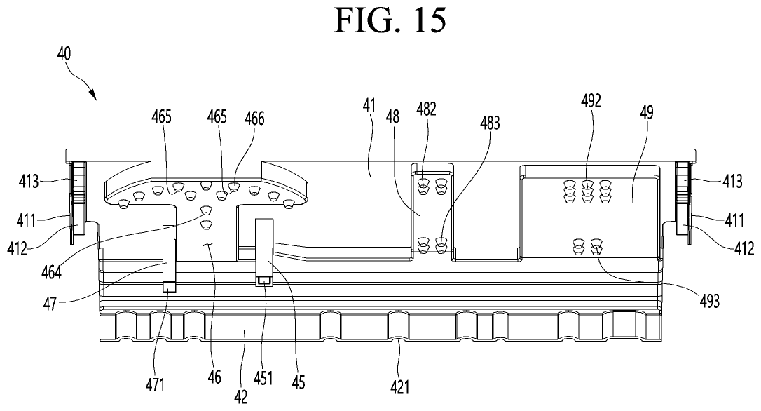

Meanwhile, a mixing member 60 may be provided inside the first receiving portion 54. The mixing member 60 may be formed in the shape of a fan or propeller having multiple blades. Furthermore, the mixing member 60 may be rotatably arranged in the first receiving portion 54. The mixing member 60 may be rotated by water sprayed from the nozzle 451 (See FIG. 15) formed in the flow path member 40. The mixing member 60 may be defined as a mixing member or mixing fan.

When washing water is supplied through the nozzle 451 in a state where powdered detergent is introduced into the first receiving portion 54, the mixing member 60 rotates to mix the washing water and the powdered detergent. The powdered detergent dissolved in the washing water can then be supplied to the tub 11 from the first receiving portion 54. For this purpose, at least a portion of the rear of the first receiving portion 54 can be opened.

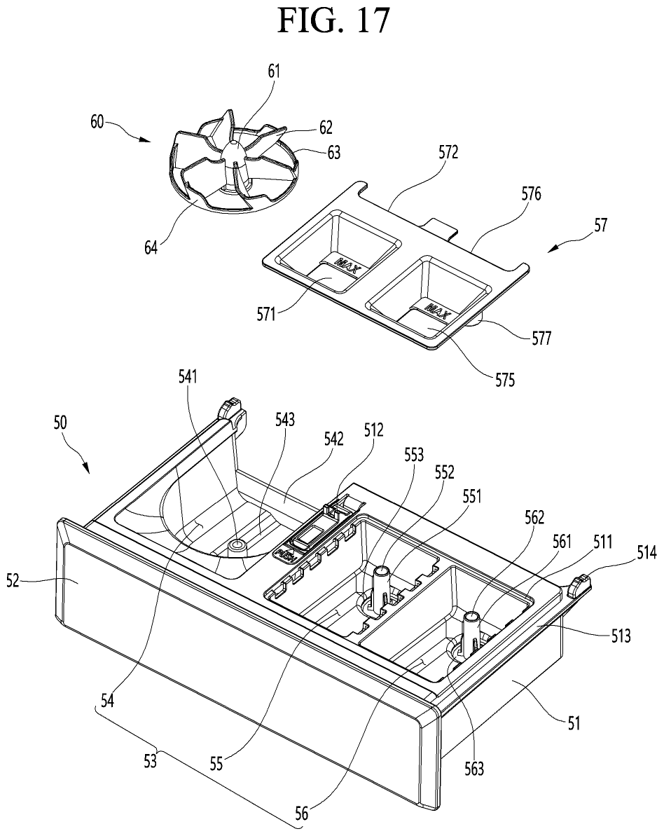

The second receiving portion 55 and third receiving portion 56 may be provided with a receiving portion cover 57. The receiving portion covers 57 may be placed on the open upper surfaces of the second receiving portion 55 and third receiving portion 56, and may be formed to slope downward along the concave shapes of the second receiving portion 55 and third receiving portion 56. Furthermore, cover holes 571, 572, 575, 576 (See FIG. 17) through which water falling from the flow path member 40 is supplied may be formed in the bottom portion of the recessed part of the receiving cover 57 formed with a downward slope and in the rear end of the receiving cover 57.

In this embodiment, the receiving portion cover 57 is presented in a manner that the recessed portions corresponding to the second receiving portion 55 and the third receiving portion 56 are formed as a single unit, but, it may also be provided as separate cover structures that shield the second receiving portion 55 and the third receiving portion 56 respectively.

The following describes the housing 30 in more detail with reference to the drawings.

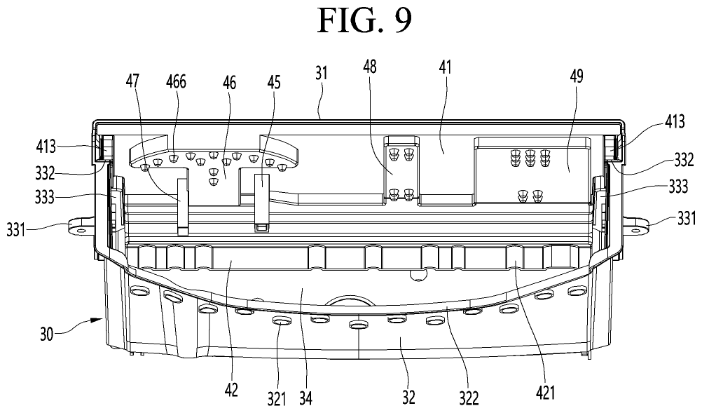

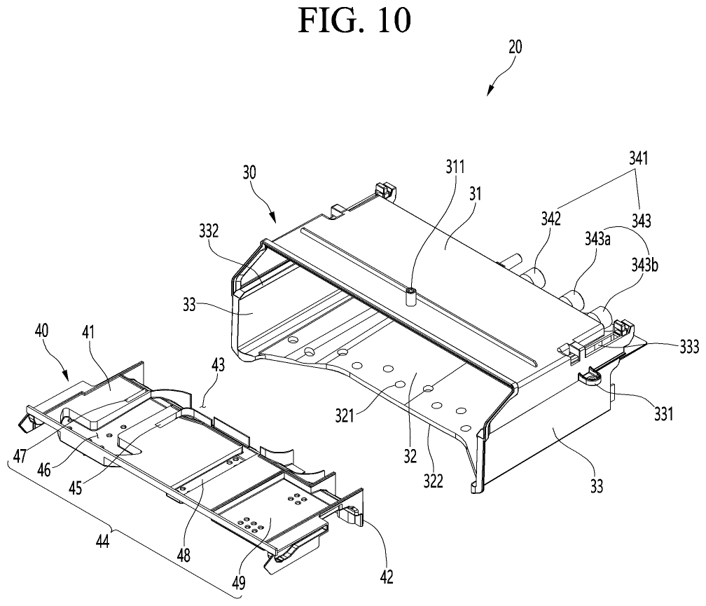

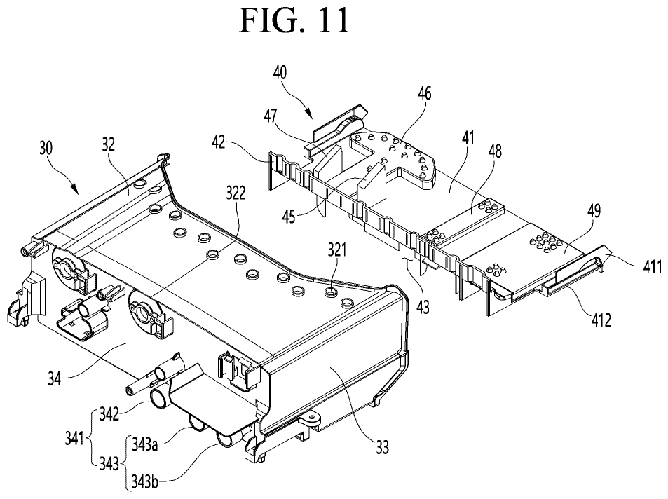

FIG. 9 is a perspective view of the housing with the flow path member attached, viewed from the front lower side, FIG. 10 is an exploded perspective view of the housing and flow path member, viewed from the top, and FIG. 11 is an exploded perspective view of the housing and flow path member, viewed from the bottom.

Referring to FIGS. 9 to 11, the housing 30 may be formed as a hexahedral shape with an open front surface and an accommodation space 300 thereinside. For example, the housing 30 may include a housing top surface 31, a housing bottom surface 32, a pair of housing side surfaces 33, and a housing rear surface 34.

The housing top surface 31 may have a housing mounting portion 311. The housing mounting portion 311 may be coupled to the upper frame 12. For example, the housing mounting portion 311 may include a boss to which a screw is fastened, and may be formed at a position corresponding to a frame coupling portion 122 (See FIG. 3) of the upper frame 12. Furthermore, a screw penetrating the frame coupling portion 122 is fastened to the housing mounting portion 311, thereby securing the housing 30 to the upper frame 12.

Additionally, a side mounting portion 331 may protrude from the outer surface of the housing side surface 33. In detail, the side mounting portion 331 protrudes laterally from the housing side surface 33, and a screw penetrating the side mounting portion 331 is connected to the upper frame 12, allowing the housing 30 to be securely fixed inside the upper frame 12.

The housing side surface 33 has a housing guide 332 formed in a stepped manner to guide the insertion and removal of the drawer 50, and the upper surface of the housing guide 332 accommodates the drawer guide 513 (See FIG. 17) formed on the drawer 50. The housing guide 332 may extend from the front end to the rear end of the housing side surface 33. Furthermore, the housing guide 332 is stepped toward the center of the storage space 300, allowing the drawer guide 513 to rest on the upper surface of the housing guide 332.

A drawer retaining portion 333 may be formed at the rear end of the housing side surface 33. The drawer retaining portion 333 may be formed to extend from a point where is rearwardly spaced apart from the front end of the housing side surface 33 to the rear end of the housing side surface 33. Furthermore, the drawer retaining portion 333 protrudes downward from the upper surface of the housing 30 and is positioned above the housing guide 332.

Additionally, an elastic member is mounted on the drawer retaining portion 333, and the elastic member can press against the upper surface of a drawer retaining protrusion 514 (See FIG. 17) of the drawer 50 when the drawer 50 is fully inserted into the interior of the housing 30, thereby restricting the withdrawal of the drawer 50. That is, the drawer 50 can be pulled out only when the user pulls the drawer 50 with a force that overcomes the elastic force of the elastic member.

The housing bottom surface 32 may include a housing discharge port 321 that allows the washing water mixed with detergent from the drawer 50 to fall downward. The housing discharge port 321 may be arranged in a plurality in an area adjacent to the front end 322 of the housing bottom surface 32. Furthermore, the front end 322 of the housing bottom surface 32 may be formed in a shape that is rearwardly recessed. For example, the front end 322 of the housing bottom surface 32 may have a shape in which the central portion is more concave rearwardly than the left and right sides. Therefore, the front end (322) becomes longer than that the front end 322 is straight, allowing the washing water flowing along the housing bottom surface 32 to fall evenly over a wider area.

The housing rear surface 34 may be equipped with the water supply device 15. Additionally, the housing rear surface 34 may have a connection port 341 that protrudes rearwardly. The connection port 341 may be connected to the water supply body 151. The connection port 341 may include a hot water port 342 and a cold water port 343. The cold water port 343 may include a first cold water port 343a and a second cold water port 343b.

The hot water port 342, the first cold water port 343a, and the second cold water port 343b may be arranged side by side in along the same plane. When the water supply device 15 is installed, the hot water port 342 may be opened or closed by the hot water valve 153, and the first cold water port 343a and second cold water port 343b may be opened or closed by the first cold water valve 154a and second cold water valve 154b, respectively. Furthermore, the hot water port 342, the first cold water port 343a, and the second cold water port 343b communicate with the distribution path 43 formed in the flow path member 40 when the flow path member 40 is installed.

The flow path member 40 may be formed to a size corresponding to the housing upper surface 31. For example, when the flow path member 40 is mounted on the housing upper surface 31, the front and rear ends of the flow path member 40 extend to the front and rear ends of the housing upper surface 31, and the left and right sides of the flow path member 40 may be formed to extend to the left and right sides of the housing upper surface 31.

Furthermore, the rear end of the flow path member 40 extends downward and may come into contact with the housing rear surface 34. Additionally, the rear surface of the flow path member 40 may be connected to the connection port 341 connected to the water supply device 15.

The flow path member 40 may include a distribution path 43 and a discharge path 44 for supplying water to the receiving portion 53. The discharge path 44 may be formed with a predetermined depth of recess and may form independent flow passages by a coupling of the housing 30. The following describes the structure and function of the flow path member 40 including the paths 43, 44 in more detail with reference to the drawings.

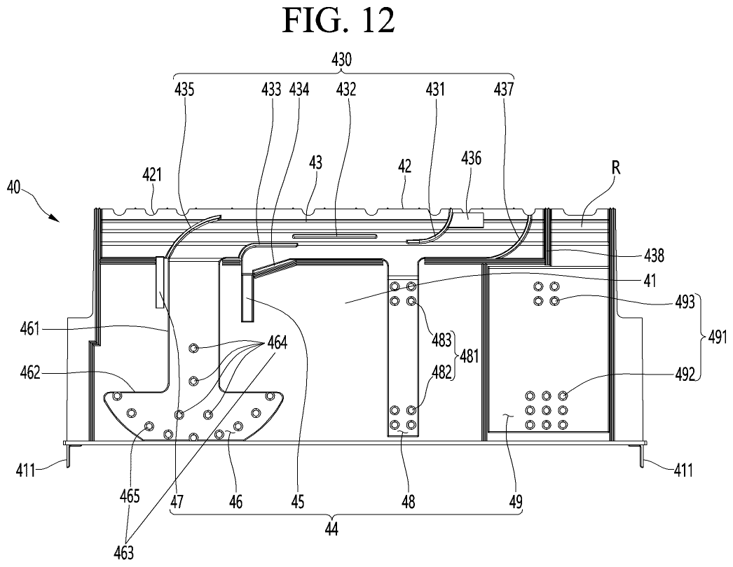

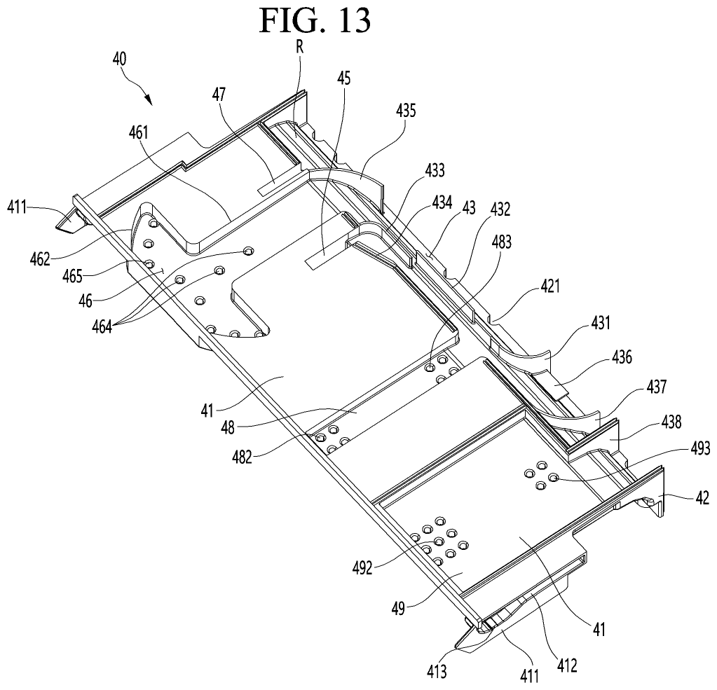

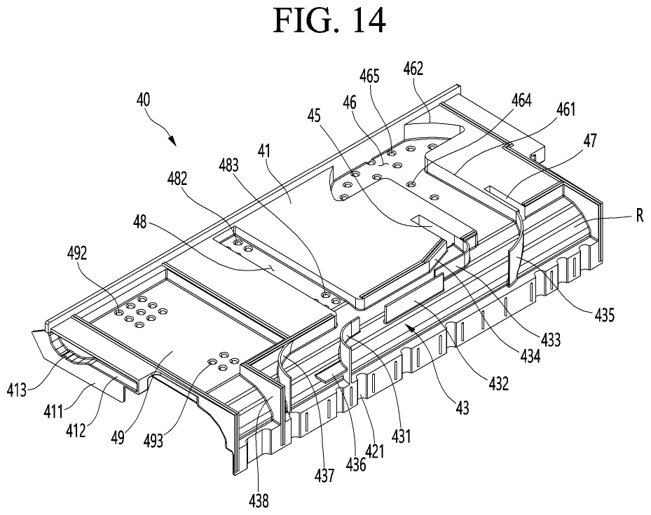

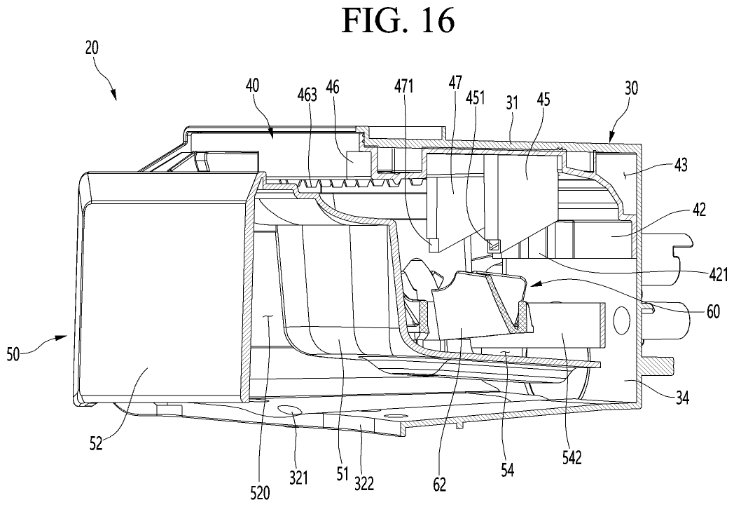

FIG. 12 is a plan view of the flow path member, FIG. 13 is a perspective view of the flow path member as seen from above, FIG. 14 is a perspective view of the flow path member as seen from the rear, FIG. 15 is a perspective view of the flow path member as seen from below, and FIG. 16 is a sectional perspective view along the 16-16 section of FIG. 5.

Referring to FIGS. 12 through 16, the flow path member 40 may include an upper part 41, a rear part 42, and a corner part R where the rear end of the upper part 41 and the upper end of the rear part 42 meet. The upper part 41 may be defined as the surface facing the housing upper surface 31. A portion of the upper part 41 contacts the housing upper surface 31, while the other portion is recessed to form a flow path through which water supplied to the drawer 50 flows. That is, the open upper surfaces of the flow paths formed in the flow path member 40 can be shielded by the housing upper surface 31. The corner part R can be formed in a shape that is convexly rounded in a rearward direction.

The rear part 42 may extend downward from the rear end of the upper part 41. Furthermore, the rear part 42 may come into contact with the housing rear surface 30. Furthermore, the corner part R is spaced apart from the corner where the housing upper surface 31 and housing rear surface 34 meet, thereby forming a predetermined space between the rear surface of the flow path member 40 and the rear corner of the housing 30. The predetermined space can be defined as a washing water supply space and communicates with the connection port 341. Therefore, water supplied from the water supply device 15 to the housing 30 can be supplied to the upper part 41 via the washing water supply space. That is, the washing water discharged from the water supply device 15 and hitting the corner part R naturally flows toward the flow path formed in the upper part 41.

Meanwhile, the flow path may include a distribution path 43 and a discharge path 44. The discharge path 44 may supply water supplied from the distribution path 43 to the drawer 50.

For example, the discharge path 44 may include a first discharge path 45 that supplies water to the first receiving portion 54, and a second discharge path 46 and a third discharge path 47 that supply water to the mixing member 60. The distribution path 43 functions to divide and supply the water supplied from the water supply device 15 to the first to third discharge paths 45, 46, 47.

Furthermore, the discharge path 44 may further include a fourth discharge path 48 that supplies water to the second receiving portion 55.

Furthermore, the discharge path 44 may further include a fifth discharge path 49 that supplies water to the third receiving portion 56.

The distribution path 43 may extend laterally along the rear end of the flow path member 40. Furthermore, the distribution path 43 may distribute water to the first discharge path 45, the second discharge path 46, and the third discharge path 47. Furthermore, the distribution path 43 may also distribute water toward the fourth discharge path 48.

In detail, the distribution path 43 can be formed at the corner part R. Furthermore, the hot water port 342 and the cold water port 343 are connected to the distribution path 43, allowing hot water and cold water to be supplied to the distribution path 43. The hot water port 342 and the cold water port 343 may be positioned offset toward either the left or right edge of the distribution path 43. The hot water port 342 and cold water port 343 may be positioned closer to the first discharge path 45 than to the second discharge path 46.

Furthermore, the distribution path 43 may include a plurality of distribution ribs 430. The water flowing along the distribution path 43 is divided into the first to fifth flow paths 45 to 49 by the distribution ribs 430. The distribution path 43 can be understood as the flow pah formed between the distribution rib formed at the far left and the distribution rib formed at the far right.

The distribution rib 430 may include a guide rib 437 that guides the water flowing into the flow path member 40 in one side direction. Based on the lateral direction of the flow path member 40, the hot water port 342 and cold water port 343 may be positioned offset to one side (the right side in FIG. 12). In particular, the cold water port 343 may be positioned at the right end of the distribution path 43.

Therefore, the guide rib 437 may be formed on the edge of the distribution path 43 corresponding to the position where the cold water port 343 is located. The guide rib 437 may be formed with a predetermined curvature or inclination to guide the water supplied from the cold water port 343 toward the left edge of the distribution path 43.

For example, the guide rib 437 may be formed to extend forward from the rear end of the distribution path 43 and to be rounded or sloped toward the left edge of the flow path member 40.

The distribution rib 430 may further include a first distribution rib 431 for guiding the flow of hot water and cold water. The first distribution rib 431 may be formed with a predetermined curvature at a point spaced apart from the guide rib 437 toward the left edge of the flow path member 40.

In detail, the first distribution rib 431 may extend to be rounded forward from the rear end of the distribution path 43, i.e., the rear end of the flow path member 40. Furthermore, the rear end of the first distribution rib 431 may be positioned between the hot water port 342 and the cold water port 343. Additionally, the first distribution rib 431 may extend to be rounded toward the first discharge path 45 and the second discharge path 46. Therefore, the water discharged from the hot water port 342 can be guided toward the first and second discharge paths 45, 46 by the first distribution rib 431. Furthermore, the water discharged from the first cold water port 34a can be guided toward the first and second discharge paths 45, 46 by the first distribution rib 431 and the guide rib 437.

The first distribution rib 431 may extend to the vicinity of the inlet of the fourth discharge path 48. Therefore, hot water and cold water may be guided along the first distribution rib 431. Furthermore, at least a portion of the supplied hot water and cold water can be mixed at the end of the first distribution rib 431 and guided toward the fourth discharge path 48. Furthermore, the remaining portion of the supplied hot water and cold water can be supplied to the first to third discharge paths 45, 46, 47 formed at the point where is offset to the left from the fourth discharge path 48.

Furthermore, an auxiliary rib 436 may extend horizontally and laterally from a side of the rear end of the first distribution rib 431 (the right side in FIG. 12). The auxiliary rib 436 may extend toward the cold water port 343, specifically the first cold water port 343a. Furthermore, the auxiliary rib 436 may extend from a point downwardly spaced apart from the upper end of the first distribution rib 431. Additionally, the front end of the auxiliary rib 436 may be extended forward to contact the corner part R. By forming the auxiliary rib 436, it is possible to prevent cold water introduced from the rear of the flow path member 40 from bypassing excessively downward, and to allow the cold water to flow along the first distribution rib 431 toward the discharge paths 45 to 48 that constitute the discharge path 44.

The distribution rib 430 may include a second distribution rib 432 that guides the flow of hot water and cold water that has passed through the first distribution rib 431. The second distribution rib 432 may extend in a straight line for a predetermined length toward the left end of the flow path member 40 from a point where is spaced apart toward the left end of the flow path member 40 from the end of the first distribution rib 431.

Additionally, the second distribution rib 432 may extend upward from the corner part R to a predetermined height. Furthermore, the second distribution rib 432 may be positioned at a point rearwardly spaced apart from the end of the first distribution rib 431. Therefore, the hot water discharged from the hot water port 342 may flow along the left side of the first distribution rib 431 and then be divided into the front and rear sides of the second distribution rib 432.

The second distribution rib 432 extends straight in the left-right direction, enabling the cold water and hot water passing through the first distribution rib 431 to maintain their straightness. Furthermore, depending on the front-to-back spacing between the second distribution rib 432 and the first distribution rib 431, the hot water can flow in a front-to-back direction at a set ratio, and the hot water and cold water can be designed to flow in a state where they are mixed at an appropriate ratio.

At this time, the mixing ratio of hot water and cold water can be determined based on the front-to-back distance between the end of the first distribution rib 431 and the second distribution rib 432, and the width of the front-to-back flow passages with respect to the second distribution rib 432. The widths of the front-to-back flow passages with respect to the second distribution rib 432 can be understood to mean the width between the rear of the housing 30 and the second distribution rib 432, and the width between the second distribution rib 432 and the front end of the corner part R, i.e., the front end of the washing water supply space.

The distribution rib 430 may further include a third distribution rib 433 that guides water flowing toward the first discharge path 45 and the second discharge path 46. In detail, the third distribution rib 433 may extend between the first discharge path 45 and the second discharge path 46. For example, the front end of the third distribution rib 433 may be located closer to the end of the first discharge channel 45.

The third distribution rib 433 may extend rearward. Furthermore, the front portion of the third distribution rib 433 may be formed in a rounded shape, and the rear portion may extend parallel to the second distribution rib 432.

On the other hand, the right end (rear end) of the third distribution rib 433 is located at a point spaced forward from the second distribution rib 432, and is positioned at a point spaced apart from the left end of the second distribution rib 432 toward the right, such that the third distribution rib 433 and the second distribution rib 432 can overlap for a predetermined length in the front-rear direction. Furthermore, the third distribution rib 433 extends straight to the left for a predetermined length and then curves forward, such that the left end (front end) of the third distribution rib 433 can be connected to the left edge of the inlet of the first distribution path 45. Therefore, the washing water flowing toward the front of the third distribution rib 433 is guided into the first discharge path 45, and the washing water flowing toward the rear of the third distribution rib 433 is guided into the second discharge path 46.

At this time, cold water passing through the gap between the second distribution rib 432 and the third distribution rib 433 can be mixed with the hot water flowing along the second distribution rib 432 and then guided into the second discharge path 46. The amount of washing water guided into the second discharge path 46 and the mixing ratio of hot water and cold water may vary depending on the front-to-back spacing distance between the second distribution rib 432 and the third distribution rib 433.

The distribution rib 430 may further include a fourth distribution rib 434. The fourth distribution rib 434 is a rib connecting the right side end of the inlet of the first discharge path 45 and the rear end of the upper part 41, and may be formed to slope forward from right to left. In detail, the left and right ends of the inlet of the first discharge path 45 may be connected to the third distribution rib 433 and the fourth distribution rib 434, respectively. Therefore, the washing water can be guided into the first discharge path 45 by the third distribution rib 433 and the fourth distribution rib 434. Furthermore, the flow rate of water distributed to the first discharge path 45 and the second discharge path 46 can be determined by the arrangement position and shape of the third distribution rib 433.

The distribution path 43 may further include a fifth distribution rib 435. Specifically, the fifth distribution rib 435 may extend forward from the rear end of the corner part R and be positioned between the inlet of the second discharge path 46 and the inlet of the third discharge path 47. The fifth distribution rib 435 may extend toward the front in a rounded or sloped manner as it moves toward the left. Furthermore, the fifth distribution rib 435 may be understood as a rib extending from the rear end of the corner part R to the front end. Therefore, the rear end of the fifth distribution rib 435 is located at the rear of the second distribution rib 432 and may be positioned at a point spaced forward from the rear end of the flow path member 40 (or the rear surface of the housing 30). Therefore, a portion of the washing water flowing past the second distribution rib 432 and the third distribution rib 433 to the left side of the flow member 40 can be guided to the third discharge path 47.

The left end of the distribution path 43 is defined by the left edge of the flow path member 40, and the right end thereof may be defined by a barrier 438. In detail, the barrier 438 extends from the rear end of the flow path member 40 to the front end of the corner part R and may be formed at a point spaced apart from the right end of the flow path member 40 toward the left.

Furthermore, the barrier 438 is connected to the left edge of the inlet of the fifth discharge path 49, and the right edge of the inlet of the fifth discharge path 49 may be defined by the right side of the flow path member 40. Furthermore, the second cold water port 343b is connected to the inlet of the fifth discharge path 49, enabling independent supply of cold water to the fifth discharge path 49. That is, the cold water discharged from the second cold water port 343b can only be supplied to the fifth discharge path 49. Here, the flow path connecting the inlet of the fifth discharge path 49 and the rear surface of the housing 30 can be defined as an additional distribution path that is distinct from the distribution path 43.

Meanwhile, the inlet (or rear end) of the discharge path 44 communicates with the front end of the distribution path 43 and may be extended forward by a predetermined length. The discharge path 44 may be formed to be recessed or stepped downward by a predetermined depth from the upper surface of the upper part 41. Furthermore, the upper surface of the upper part 41 excluding the discharge path 44 contacts the lower surface of the housing upper surface 31. Therefore, the upper surface of the discharge path 44 is shielded by the coupling of the housing 30 and the path member 40, thereby completing an enclosed flow path.

The first to third discharge paths 45, 46, 47 are arranged within the space defined by the first receiving portion 54 when viewed from above the first receiving portion 54, and are provided to supply washing water to the first receiving portion 54.

In detail, the first discharge path 45 extends forward from the front end of the distribution path 43 toward the blades of the mixing member 60. That is, the first discharge passage 45 may extend toward a point spaced radially to the right of the rotational center of the mixing member 60. Furthermore, an open nozzle 451 may be formed at the front lower portion of the first discharge passage 45. The nozzle 451 may be opened toward the surface of the blade 62, and the opening shape of the nozzle 451 may be designed in various shapes.

Meanwhile, the lower surface of the first discharge path 45 may be inclined downward toward the cutting edge. Furthermore, the nozzle 451 may be opened at the front lower end of the first discharge path 45. Therefore, the water sprayed from the nozzle 451 strikes the surface of the blade 62 at a downward angle, causing the mixing member 60 to rotate. For example, the slope angle of the bottom surface of the first discharge path 45 may be set so that the washing water sprayed from the nozzle 451 and the surface of the blade 62 intersect perpendicularly. The nozzle 451 may be defined as the first nozzle 451.

Furthermore, the first discharge path 45 is located at a point radially spaced from the rotation axis 61 of the mixing member 60, so that the mixing member 60 rotates due to the moment generated by the washing water sprayed from the nozzle 451. Therefore, the farther the point where the water sprayed from the first nozzle 451 hits the blade surface of the mixing member 60 is from the rotation axis 61 of the mixing member 60, the faster the rotation speed of the mixing member 60 will be. Therefore, the extension position of the first nozzle 451 can be appropriately set according to the rotational speed of the mixing member 60 that optimizes the mixing of the washing water and detergent.

Since the first discharge path 45 only needs to provide sufficient flow rate to rotate the mixing member 60 at the set speed, the width of the first discharge path 45 can be designed to be narrower than that of the second discharge path 46.

The second discharge path 46 extends forward from the distribution path 43 and may extend through the center of the first receiving portion 54. Furthermore, the left edge of the second discharge path 46 may extend forward from the end of the fifth distribution rib 435. Furthermore, the second discharge path 46 may extend to the front end of the first receiving portion 54. Additionally, the second discharge path 46 may extend to the front end of the flow path member 40. Here, the first receiving portion 54 may be limited to the portion rounded along the circumferential surface of the mixing member 60. The recessed portion on upper end of the front side of the first receiving portion 54 may be understood as a guide portion formed to collect the scattered washing water into the first receiving portion 54.

The second discharge path 46 may be configured to allow water for dissolving the powdered detergent filled in the first receiving portion 54 and washing off the detergent adhering to the surface of the first receiving portion 54 to fall from the upper side of the first receiving portion 54. For this purpose, the second discharge path 46 may have a plurality of shower holes 463. The shower holes 463 are evenly arranged within the first receiving portion 54 to minimize the phenomenon of powdered detergent remaining inside the first receptacle 54. The shower holes 463 may be defined as first shower holes 463 to distinguish them from the second shower holes 481 and third shower holes 491 described below.

Furthermore, the second discharge path 46 may include a main portion 461 extending forward from the distribution path 43 and an extended portion 462 extending laterally from the front end of the main portion 461. That is, the main portion 461 may be designed to correspond to the body portion of the arrow, and the extended portion 462 may be designed to correspond to the head portion of the arrow.

Furthermore, the first shower hole 463 may be formed in a plurality along the main portion 461 and the extended portion 462. The first shower hole 463 may be formed to penetrate the flow path member 40 in the vertical direction. Furthermore, the first shower hole 463 is formed on the a shower part 466, which is a nozzle-shaped protrusion extending downward from the lower surface of the flow path member 40. However, depending on the shape of the shower part 466 or the arrangement of the first shower hole 463, the first shower hole 463 may not penetrate the flow path member 40 vertically downward but may penetrate it at a downwardly inclined angle.

The main body 461 extends from the distribution path 43 and may further extend forward past the center of the mixing member 60. Furthermore, the extended portion 462 may extend from the front end of the main portion 461 to the front edge of the flow path member 40, and may extend in a form that expands to the left and right sides with respect to the main portion 461. At least a portion of the edge of the extended portion 462 may be formed with a curvature corresponding to the curvature of the front edge of the first receiving portion 54. The first shower hole 463 may be formed in the main portion 461 and the extended portion 462.

The first shower hole 463 may include a main shower hole 464 formed in the main part 461 and an extended shower hole 465 formed in the extended part 462. The main shower hole 464 may be provided in plurality and may be arranged at a position overlapping the mixing member 60 when viewed from above.

For example, the main shower hole 464 may be formed on a vertical line passing through the rotation axis 61 of the mixing member 60. Therefore, the washing water passing through the main shower hole 464 falls onto the tip of the rotation axis 61 and flows along the surface of the rotation axis 61, thereby washing off the powdered detergent adhering to the rotation axis 61. Furthermore, the main shower hole 464 may be further formed on the upper side of the blade 62 of the mixing member 60. Therefore, the washing water falling from the main shower hole 464 can wash off the powdered detergent adhering to the surface of the blade 62.

The extended shower holes 465 may be arranged in a spaced-apart manner along the front end of the extended portion 462. When viewed from above, the extended shower holes 465 may be located right above the rounded front surface of the first receiving portion 54. For example, since the front surface of the first receiving portion 54 is formed in a rounded shape, the plurality of extended shower holes 465 may also be arranged along a virtual arc line extending along the front surface of the first receiving portion 54. Additionally, one or more extended shower holes 465 may be further formed at the point between the edge of the blade 62 and the rotation axis 61. In this case, the position of the extended shower holes 465 may be formed at the point corresponding to a ring 63 of the mixing member 60. Therefore, the water falling from the main shower holes 464 can wash off the powdered detergent adhering to the blades 62, particularly the ring 63.

The third discharge path 47 is for washing powder detergent adhering to the surface of the blade 62 and may be arranged on the side of the second discharge path 46. Furthermore, the first discharge path 45 and the third discharge path 47 may be arranged side by side on opposite sides of the second discharge path 46. The surface (rear side) of the blade 62 where the washing water discharged from the third discharge path 47 strikes can be understood as the opposite side of the surface (front side) of the blade 62 where the washing water sprayed from the nozzle 451 of the first discharge path 45 strikes.

The third discharge path 47 may extend forward from the distribution path 43. The third discharge path 47 may be recessed into the upper part 41. Furthermore, the third discharge path 47 may extend to a position where it overlaps at least part of the mixing member 60 in the vertical direction when viewed from above. The third discharge path 47, like the first discharge path 45, may be formed with a downward slope toward the front.

A second nozzle 471 that sprays water in the opposite direction of the rotation of the mixing member 60 may be formed at the front lower end of the third discharge path 47. The second nozzle 471 may be formed at the lower end of the third discharge path 47. The water sprayed from the second nozzle 471 is directed toward the rear surface of the blade 62.

The width of the third discharge path 47 may be formed smaller than the width of the first discharge path 45, thereby forming a smaller flow rate in the third discharge path 47. Therefore, the mixing member 60 can be prevented from rotating in the reverse direction or stopping by the water sprayed from the second nozzle 471. Furthermore, the second nozzle 471 can be positioned further rearward than the first nozzle 451. That is, the first discharge path 45 may extend further forward than the third discharge path 47.

Furthermore, the gap between the left sides of the third discharge path 47 and the second discharge path 46 may be set smaller than the gap between the right sides of the first discharge path 45 and the second discharge path 46. In other aspect, it can be explained that the distance between the third discharge path 47 and the rotation axis of the mixing member 60 is set to be smaller than the distance between the first discharge path 45 and the rotation axis of the mixing member 60.

In detail, the reverse rotational moment M2 acting on the mixing member 60 due to the washing water sprayed from the second nozzle 471 acts in the opposite direction to the forward rotational moment M1 acting on the mixing member 60 due to the washing water sprayed from the first nozzle 451. Therefore, by forming the reverse rotational moment M2 to be smaller than the forward rotational moment M1, it is possible to minimize interference with the forward rotation of the mixing member 60.

Meanwhile, the fourth discharge path 48 may be located on the upper side of the second receiving portion 55. The fourth discharge path 48 may extend forward from the distribution path 43. The fourth discharge path 48 may be formed in front of the first distribution rib 431, and the inlet of the fourth discharge path 48 may be formed at a position spaced forward from the front end of the first distribution rib 431. More specifically, the front end of the first distribution rib 431 may be located between the left edge and the right edge of the fourth discharge path 48. Furthermore, the fourth discharge path 48 may extend forward beyond the center of the second receiving portion 55.

The fourth discharge path 48 may be recessed downward from the upper part 41. Furthermore, a plurality of second shower holes 481 may be formed in the fourth discharge path 48. The second shower holes 481 may open by passing through the fourth discharge path 48 and may be configured to allow water supplied to the fourth discharge path 48 to fall downward.

The second shower holes 481 may include a plurality of first front holes 482 and a plurality of first rear holes 483. The first front holes 482 may be formed at a position corresponding to the first front cover hole 571 of the receiving portion cover 57 that is mounted on the second receptacle 55. The first rear holes 483 may be formed at positions corresponding to the first rear cover holes 572 of the receiving portion cover 57. Therefore, the first rear holes 483 may be located to the rear of the first front holes 482.

The fifth discharge path 49 may be located above the third receiving portion 56. The fifth discharge path 49 may extend forward from the distribution passage 43. The fifth discharge path 49 communicates with an additional distribution path formed between the barrier 438 and the right side of the flow path member 40, and the width of the fifth discharge path 49 may be larger than the width of the additional distribution path. That is, the right side of the fifth discharge path 49 is defined by the right side of the flow path member 40, and the left side of the fifth discharge path 49 may be formed at a point spaced apart from the barrier 438 to the left.

The additional distribution path is positioned in front of the second cold water port 343b, and the washing water flowing into the second cold water port 343b is supplied to the fifth discharge path 49. Furthermore, the fifth discharge path 49 may extend forward beyond the center of the third receiving portion 56.

The fifth discharge path 49 may be recessed downward from the upper part 41. Furthermore, the fifth discharge path 49 may have a plurality of third shower holes 491 formed therein. The third shower holes 491 may be formed to open through the fifth discharge path 49 and may be configured to allow water supplied to the fifth discharge path 49 to fall downward.

The third shower holes 491 may include a plurality of second front holes 492 and a plurality of second rear holes 493. The second front holes 492 may be formed in a greater number than the second rear holes 493 so that a greater amount of water is supplied to the front side than to the rear side of the third receiving portion 56.

The second front hole 492 may be formed at a position corresponding to the second front cover hole 575 of the receiving portion cover 57 disposed on the third receiving portion 56. The second rear hole 493 may be formed at a position corresponding to the second rear cover hole 576 of the receiving portion cover 57. Therefore, the second rear hole 493 may be located to the rear of the second front hole 492.

Meanwhile, a plurality of drain portions 421 may be recessed on the rear surface of the rear part 42. The drain portions 421 are provided to prevent water supplied into the housing 30 from flowing back, and may be forwardly recessed from the rear surface of the rear part 42 and extend in length from the upper end to the lower end of the rear part 42. Furthermore, the plurality of drain portions 421 may be spaced apart in the width direction of the rear part 42. Therefore, when the water pressure from the water supply device 15 is high, some of the supplied water flows downward through the drain sections 421 to the rear side of the housing 30. By the plurality of drain portions 421, even if the pressure of the water supplied from the water supply device 15 suddenly increases, the phenomenon of water flowing back into the water supply device 15 or the water supply pipe connection portion 152 and causing leakage can be prevented.

Side guides 412 may be formed on both side ends of the flow path member 40. The side guides 412 may extend backward from the front end of the flow path member 40 for a predetermined length, having a predetermined width from the side edges of the flow member 40. Furthermore, a side retaining portion 413 may protrude downward from the lower surface of the side guide 412. The side retaining portion 413 protrudes downward from the front end of the side guide 412, such that, when the drawer 50 is fully extended, the side retaining portion 413 interferes with a retaining protrusion 514 (See FIG. 17) formed on the drawer 50 to prevent the drawer 50 from separating.

In a state where the flow path member 40 is mounted on the housing 30, the side guide 412 can be positioned above the housing guide 332. Furthermore, in a state where the drawer 50 is inserted, the drawer guide 513 may be positioned between the housing guide 332 and the side guide 412.

Additionally, the lower surface of the side guide 412 may come into contact with the upper end of the locking protrusion 514 of the drawer guide 513. Furthermore, when the drawer 50 is fully extended, the upper end of the retaining protrusion 514 engages with the side retaining portion 413, thereby preventing the front end of the drawer 50 from sagging downward.

Meanwhile, side walls 411 may be formed on both ends of the flow path member 40 corresponding to the bottom surface of the side guide 412. The side walls 411 extend downward from the outermost edge of the bottom surface of the side guide 412 and extend rearward for a predetermined length so that, when the flow path member 40 is mounted on the housing 30, the side walls 411 come into contact with the side surface of the housing 30. Therefore, the drawer guide 513 is positioned between the lower end of the side wall 411 and the upper surface of the housing guide 332.

In detail, the drawer 50 may include a drawer body 51 in which the receiving portion 53 is formed, and a drawer handle 52 formed on the front of the drawer body 51. The drawer handle 52 may be formed to shield the frame opening 121 when the drawer 50 is inserted. Furthermore, by inserting a finger into the grip groove 520 formed between the back side of the drawer handle 52 and the front side of the drawer body 51 and pulling the drawer handle 52 forward, the drawer 50 can be pulled out.

Hereinafter, the drawer 50 will described in more detail with reference to the drawings.

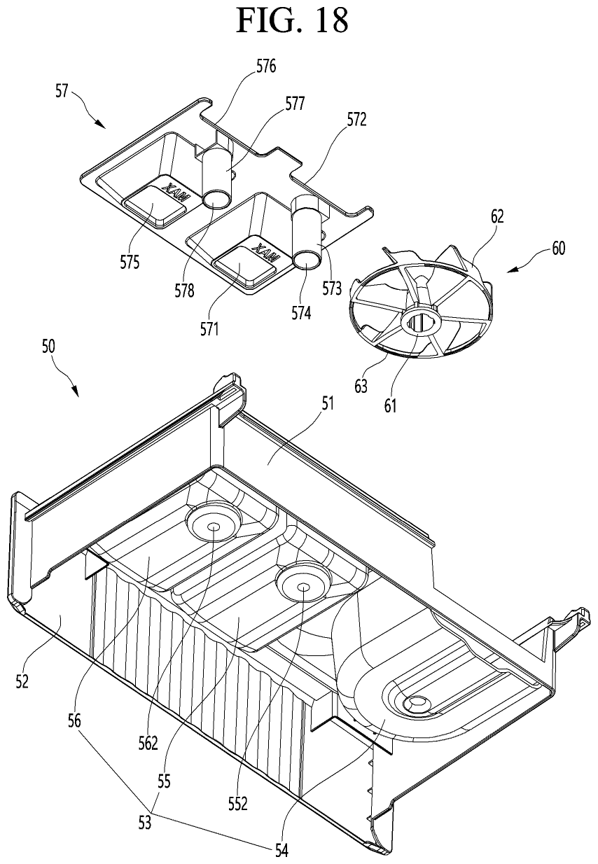

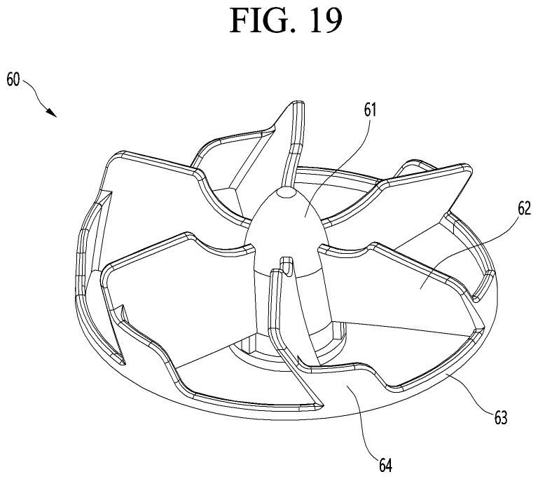

FIG. 17 is an exploded perspective view from above showing the drawer, mixing member, and receiving portion cover separated, FIG. 18 is an exploded perspective view from below showing the drawer, mixing member, and receiving portion cover separated, and FIG. 19 is a perspective view of the mixing member.

Referring to FIGS. 17 to 19, the drawer 50 is provided as a drawer with an open upper surface, which can be inserted into the receiving space of the housing 30 or pulled out forward from the receiving space.

In detail, the upper surface of the drawer body 51 may have a recessed receiving portion 53. The receiving portion 53 may include a first receiving portion 54 in which the mixing member 60 is mounted. Furthermore, the receiving portion 53 may further include a second receiving portion 55 and a third receiving portion 56 arranged side by side next to the first receiving portion 54.

The upper surface and the rear surface of the first receiving portion 54 are open, and the mixing member 60 may be received therein. Furthermore, a rotating boss 541, to which the mixing member 60 is rotatably mounted, may protrude from the bottom of the first receiving part 54. Thus, the mixing member 60 can rotate within the first receiving portion 54 about the rotating boss 541 as a central axis.

The front surface of the first receiving portion 54 forms a rounded curvature, specifically rounded with a radius of curvature slightly larger than the rotational radius of the mixing member 60, so that the mixing member 60 does not interfere with the mixing member 60 during rotation. Therefore, when the mixing member 60 is accommodated in the first receiving portion 54, the edge of the mixing member 60 and the inner surface of the first receiving portion 54 can be adjacent to each other without touching.

Furthermore, the two sides of the first receiving portion 54 extend parallel to each other. Therefore, the dissolved powder detergent and water inside the first receiving portion 54 can be smoothly discharged through the open rear surface of the first receiving portion 54.

Furthermore, a rear plate 542 may be formed on the open rear side of the first receiving portion 54. The rear plate 542 may extend horizontally to connect the rear ends of both sides of the first receiving portion 54 at a point spaced apart from the bottom of the first receiving portion 54. The rear plate 542 prevents the powdered detergent inside the first receiving portion 54 from being discharged all at once. Furthermore, the rear plate 542 prevents the mixing member 60 from detaching from the first receiving portion 54 and moving outward. The rear plate 542 may be formed at a point closer to the bottom than the upper surface of the first receiving portion 54.

Furthermore, one or more drainage grooves 543 rearwardly extending may be formed on the bottom of the first receiving portion 54. The drainage grooves 543 allow the powdered detergent and water inside the first receiving portion 54 to be easily discharged.

The mixing member 60 is provided in a fan shape and can rotate inside the first receiving portion 54 to mix the powdered detergent introduced into the first receiving portion 54 with the washing water. The mixing member 60 may include a rotating shaft 61 (or hub) mounted on the rotating boss 541 and a plurality of blades 62 extending from the rotating shaft 61. The mixing member 60 may be referred to as a mixing fan, propeller, or screw.

The rotating shaft 61 is formed at the center of the mixing member 60 and may serve as the rotational center of the mixing member 60. Additionally, the bottom of the rotating shaft 61 is open to allow the rotating boss 541 to be inserted into the interior of the rotating shaft 61. The rotating boss 541 can support the rotating shaft 61 in a rotatable state within the rotating shaft 61.

The blade 62 is formed at an angle smaller than 90 degrees relative to the bottom surface of the receiving portion 53, such that the upper end of the blade 62 is positioned at a point offset in the rotational direction of the blade 62 from the vertical plane passing through the lower end of the blade 62. In other words, the blade 62 may be formed so that it slopes toward the rotation direction of the mixing member 60 as it extends from the bottom to the top. Therefore, when the mixing member 60 rotates, the powdered detergent on the bottom of the first receiving portion 54 can be effectively mixed.

Furthermore, the blade 62 may be formed to be inclined at an angle perpendicular to the extension line of the first nozzle 451. Thus, the water sprayed from the first nozzle 451 strikes the front surface of the blade 62 vertically, causing the blade 62 to rotate.

Furthermore, the mixing member 60 may include a ring 63. The ring 63 is formed in a circular shape and may form the edge of the mixing member 60. The ring 63 may connect the ends of the multiple blades 62. The ring 63 functions to minimize vibration and maintain a stable rotational state when the mixing member 60 rotates. Furthermore, the powdered detergent mixed between the blades 62 can be guided to gather inside the ring 63.

Furthermore, auxiliary wings 64 may be formed at the ends of the blades 62. The auxiliary wings 64 may extend along the ring 63 from the ends of the blades 62. Therefore, the water and powder detergent flowing along the blades 62 can be guided to mix inside the mixing member 60 without being scattered outside the mixing member 60.

The drawer body 51 may further include a second receiving portion 55 and a third receiving portion 56. The second receiving portion 55 and the third receiving portion 56 may be arranged side by side next to the first receiving portion 54. The second receiving portion 55 and the third receiving portion 56 may have the same shape but different positions.

Hereinafter, the description is based on the shape of the second receiving portion 55, and the detailed description of the third receiving portion 56 is omitted. Of course, the second receiving portion 55 or the third receiving portion 56 may be omitted as necessary.

The second receiving portion 55 may have an open upper surface and be recessed downward. The open upper surface of the second receiving portion 55 may be formed in a rectangular shape. The bottom of the second receiving portion 55 may be formed with a slope that decreases toward the rear end. Furthermore, a siphon boss 551 that protrudes upward may be formed on the rear side of the bottom of the second receiving portion 55. An inner side of the siphon boss 551 may have a hollow space 552 that penetrates the siphon boss 551 in the vertical direction, allowing the detergent solution introduced into the second receiving portion 55 to be discharged below the drawer 50. Additionally, a siphon recess 553 may be formed at the lower edge of the siphon boss 551.

Furthermore, the drawer 50 may further include a receiving portion cover 57 placed on the second receiving portion 55. The receiving portion cover 57 may be formed as a single piece covering both the second receiving portion 55 and the third receiving portion 56, or it may consist of two separate covers.

The edges of the receiving portion cover 57 may be seated on the stepped portion 511 stepped along the upper edges of the second receiving portion 55 and the third receiving portion 56. Additionally, the lower surface of the receiving portion cover 57 may have a siphon extension portion 573 extending downward. The siphon extension portion 573 is formed in a tubular shape with an opening 574 on the bottom surface, so that when the receiving portion cover 57 is mounted on the second receiving portion 55, the siphon boss 551 can be inserted into the siphon extension portion 573.

Furthermore, the lower end of the siphon extension 537 can be seated in the siphon recess 553. At this time, the lower end of the siphon extension 573 is located lower than the bottom surface of the second receiving portion 55 and is spaced apart from the bottom surface of the siphon recess 553. In other words, the lower end of the siphon extension 573 can be positioned between the bottom of the second receiving portion and the bottom of the siphon recess 553. Therefore, when water and detergent are supplied to the second receiving portion 55, the detergent mixture rises along the space formed between the outer surface of the siphon boss 551 and the inner surface of the siphon extension 537. When the water level reaches the upper surface of the siphon boss 551, the detergent mixture can be discharged downward through the hollow portion 552 due to the siphon effect.

Meanwhile, the receiving portion cover 57 may have a first front cover hole 571 and a first rear cover hole 572. The perimeter of the first front cover hole 571 may be formed at an angle, guiding water falling from the second shower hole 481 above to pass through the first front cover hole 571.

The first rear cover hole 572 may be formed behind the first front cover hole 571. Furthermore, the first front cover hole 571 is provided at the front of the siphon extension 573, and the first rear cover hole 572 may be formed at the rear of the siphon extension 573. The first rear cover hole 572 may be recessed forward from the rear end of the receiving portion cover 57, and when the receiving portion cover 57 is seated on the drawer 50, a passage hole is formed by the rear edge of the first receiving portion 55. The passage hole is located directly below the second shower hole 481, and the washing water falling from the second shower hole 481 passes through the passage hole and fills the interior of the second receiving portion 55.

Meanwhile, the first rear cover hole 572 may overlap at least partially with the siphon recess 553 when viewed from above. Therefore, some of the washing water passing through the first rear cover hole 572 may fall directly into the siphon recess 553.

Meanwhile, the third receiving portion 56 may have the same structure and shape as the second receiving portion 55. That is, the third receiving portion 56 may have a siphon boss 561 with a hollow portion 562 and a siphon recess 563. And, the receiving portion cover 57 may cover the third receiving portion 56. The receiving portion cover 57 may have a siphon extension portion 577 into which the siphon boss 561 is inserted. Furthermore, the receiving portion cover 57 may have a second front cover hole 575 and a second rear cover hole 576. The second front cover hole 575 and the second rear cover hole 576 may be formed with the same structure and shape as the first front cover hole 571 and the first rear cover hole 572 described above.

Furthermore, a latch portion 512 may be formed on the upper surface of the drawer body 51. The latch portion 512 protrudes from the upper surface of the drawer body 51 and may be formed in an elastic hook shape. Furthermore, when the drawer 50 is fully withdrawn, the latch portion 512 can be latched and constrained to the housing 30 or the flow path member 40, thereby preventing the separation of the drawer 50. Of course, the user may pull the drawer 50 with a force exceeding the elastic force of the latch portion 512 to separate the drawer 50 from the housing 30.

Furthermore, the drawer guide 513 may extend longitudinally along the left and right sides of the drawer body 51. The drawer guide 513 may extend from the drawer handle 52 to the rear end of the drawer body 51. Furthermore, the drawer guide 513 may be mounted on the housing guide 332 to guide the sliding insertion and removal of the drawer 50.

A locking protrusion 514 may be formed at the rear end of the drawer guide 513 and protrude upward. The locking protrusion 514 may engage with the drawer retaining portion 333 when the drawer 50 is fully withdrawn, thereby preventing the separation of the drawer 50.

In the following, the water flow state of the detergent supply device 20 having the above structure is described in detail with reference to the drawings.

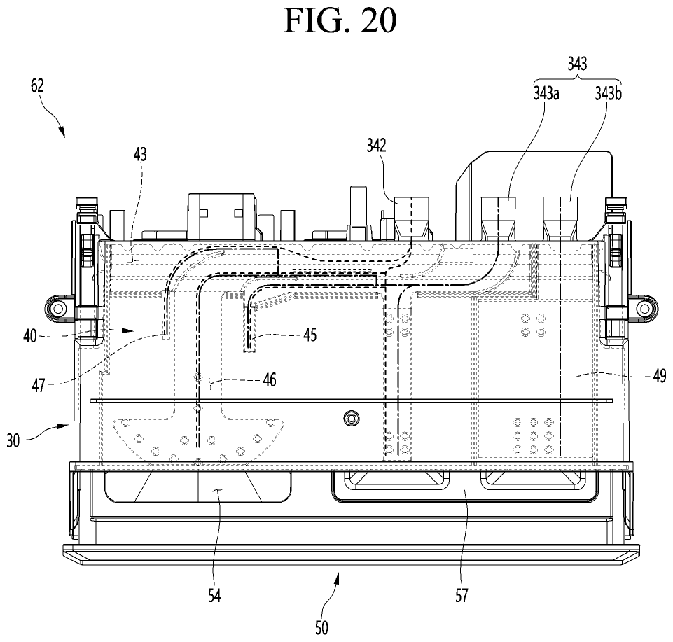

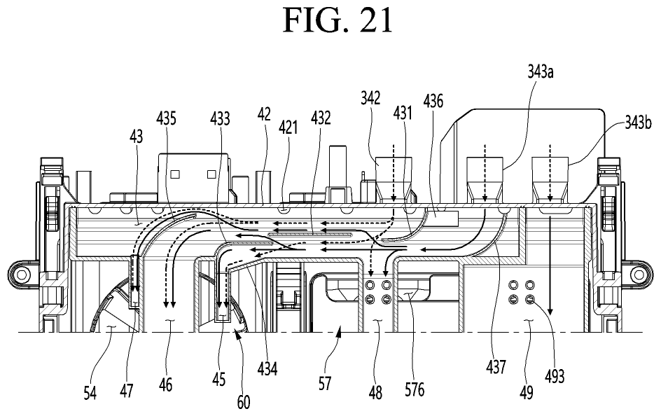

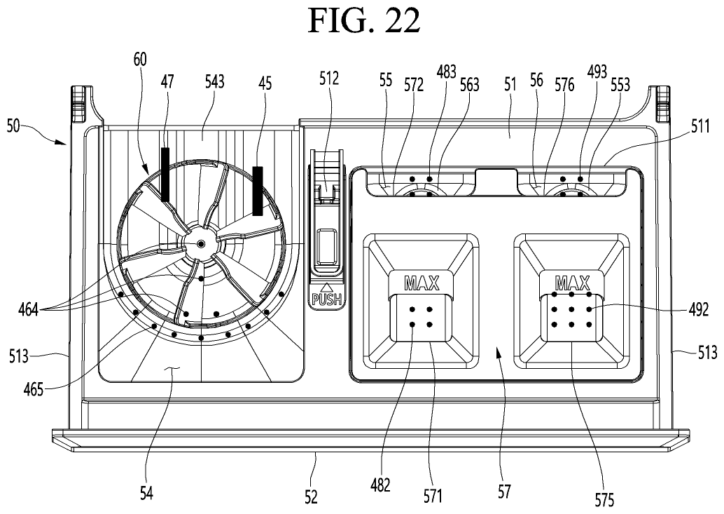

FIG. 20 is a drawing showing the flow path of the washing water supplied to the detergent supply device, FIG. 21 is a drawing showing the flow state of the washing water in the distribution path of the detergent supply device, and FIG. 22 is a drawing showing the arrangement of the water supply ports connected to each receiving portion of the drawer.

Referring to FIGS. 20 to 22, water supply to the interior of the housing 30 begins according to the operation of the water supply device 15. That is, depending on the selective operation of the hot water valve 153 and the cold water valve 154, water can be supplied to the hot water port 342 and the cold water port 343. At this time, the cold water supplied to the second cold water port 343b is directly supplied only to the fifth discharge path 49 through the additional distribution path and can be supplied to the third receiving portion.

The water supplied to the hot water port 342 and the first cold water port 343a flows into the distribution path 43. The hot water flowing into the hot water port 342 and the cold water flowing into the first cold water port 343a are mixed within the distribution path 43 and can be guided to the discharge path 44 while flowing along the distribution channel 43.

In detail, the cold water supplied through the first cold water port 343a can be guided laterally (to the left in FIG. 21) by the guide rib 437. At this time, a portion of the cold water supplied through the first cold water port 343a flows downward along the rear surface of the housing 30, while the remaining portion is guided by the auxiliary rib 436 to flow along the distribution path 43. The cold water guided by the auxiliary rib 436 passes through the passage formed along the front surface of the first distribution rib 431.

In addition, the hot water supplied through the hot water port 342 can be guided laterally (to the left side in FIG. 21) along the rear surface of the first distribution rib 431. At the end of the first distribution rib 431, the hot water and cold water can be mixed, and a portion of the mixed cold water and hot water can be guided to the fourth discharge path 48 and supplied to the second receiving portion 55.

The remaining portion of the mixed hot and cold water can be divided at the end of the second distribution rib 432 and move laterally along the front and rear surfaces of the second distribution rib 432 with straightness. At this time, the washing water moving along the front of the second distribution rib 432 is guided into the third distribution rib 433 and the fourth distribution rib 434 and flows into the first discharge path 45, and can be supplied to the first receiving portion 54 through the first discharge path 45. The washing water flowing along the first discharge path 45 is sprayed from the first nozzle 451 and hits the front of the blade 62, thereby rotating the mixing member 60.

Furthermore, the washing water moving along the rear of the second distribution rib 432 is supplied to the first receiving portion 54 through the second discharge path 46 by the third distribution rib 433 and the fifth distribution rib 435. The water supplied through the second discharge path 46 can be supplied to the inner surface of the first receiving portion 54 by the first shower hole 463. Furthermore, the water can also be supplied to the mixing member 60 through the first shower hole 463.

Meanwhile, when passing through the left end of the second distribution rib 432, the hot water and the cold water passing through the front and rear of the second distribution rib 432 can be mixed again, and the mixed water can be supplied to the second discharge channel 46 by the third distribution rib 433 and the fifth distribution rib 435.

Some of the washing water flowing along the rear of the second distribution rib 432 passes through the space between the fifth distribution rib 435 and the rear surface of the housing 30 and enters the third discharge path 47, and can be supplied to the first receiving portion 54 through the third discharge path 47. Furthermore, the washing water flowing along the third discharge path 47 can be sprayed from the second nozzle 471 to clean the rear surface of the blade 62.

Hereinafter, the behavior of the washing water supplied from the flow path member 40 to each receiving portion 53 is described in more detail with reference to the drawings.

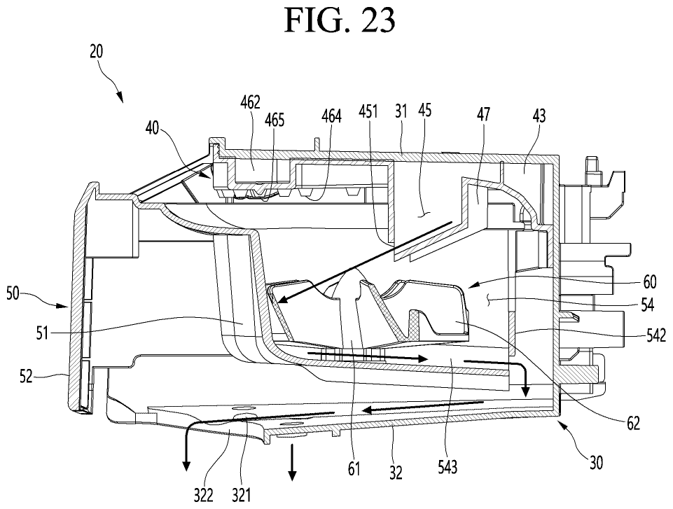

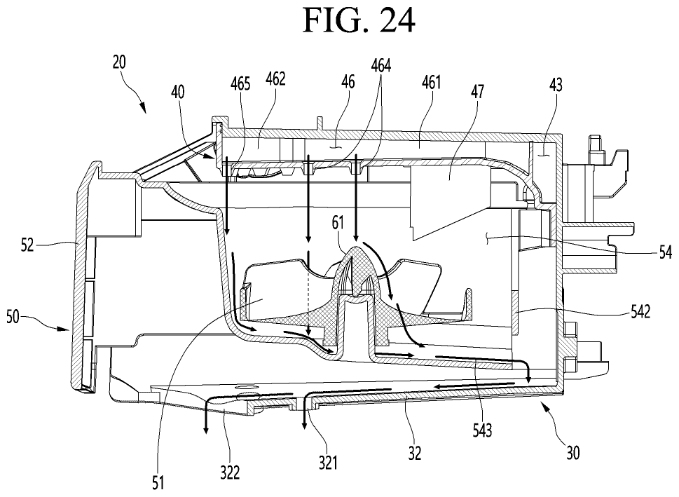

FIG. 23 is a drawing showing the washing water being sprayed into the mixing member through the nozzle of the flow path member, and FIG. 24 is a drawing showing the washing water falling into the first receiving portion through the first shower hole of the flow path member.

Referring to FIGS. 23 and 24, the water flowing along the first discharge flow path 45 flows along the downwardly inclined bottom surface of the first discharge flow path 45 and is sprayed onto the front surface of the blade 62 through the first nozzle 451 formed at the front lower end of the first discharge flow path 45.

The bottom portion of the first discharge path 45 may be inclined and extended in a direction intersecting with a surface, namely the front surface, of the blade 62. Therefore, the water sprayed from the first nozzle 451 strikes the front surface of the blade, causing the mixing member 60 to rotate. The angle α formed between the washing water sprayed from the first nozzle 451 and the front surface of the blade 62, i.e., the discharge angle of the washing water sprayed from the first nozzle 451, is 90 degrees, thereby maximizing the rotational force of the mixing member 60.

Furthermore, as the first nozzle 451 moves closer to the edge of the blade 62 than the rotation axis 61 of the mixing member 60, the rotational moment of the mixing member 60 increases. Therefore, the formation position of the first discharge passage 45 can be appropriately selected according to the design conditions.

Furthermore, while water is sprayed from the first nozzle 451, the mixing member 60 can continue to rotate. The first receiving portion 54 is filled with powdered detergent, and as the mixing member 60 rotates, it mixes the powdered detergent with water to dissolve the powdered detergent in the washing water. The powdered detergent, which may be unevenly distributed or in a lumped state within the first receiving part 54, may be crushed by the mixing member 60, dissolved in water, and then discharged toward the rear of the drawer 50.

Furthermore, the dissolved detergent discharged to the rear of the drawer 50 can be discharged into the tub 11 through the housing discharge port 321 of the housing lower surface 32 and the front end of the housing lower surface 32.

As shown in FIGS. 22 and 24, the washing water flowing along the second discharge path 46 passes through the main portion 461 and proceeds toward the extended portion 462. Furthermore, the washing water falling into the first receiving portion 54 through the first shower hole 463 of the second discharge path 46 can clean the interior of the first receiving portion 54 and the mixing member 60.

In detail, a portion of the washing water passing through the main portion 461 can fall downward through a plurality of main shower holes 464 and be supplied to the mixing member 60. The mixing member 60 can be cleaned by the water falling from the main shower holes 464.

Some of the main shower holes 464 may be located vertically above the rotating shaft 61. Therefore, the detergent adhering to the surface of the rotating shaft 61 may be washed off by the water falling from the main shower holes 464. Furthermore, some of the main shower holes 464 may be located vertically above the blade 62. Therefore, the detergent adhering to the blade 62 can be washed away by the water falling from the main shower holes 464.

The washing water flowing through the main portion 461 into the extended portion 462 fills the extended portion 462 and falls downward through a plurality of extended shower holes 465 to clean the first receiving portion 54. In detail, the extended shower holes 465 may be located vertically above the rounded front of the first receiving portion 54. In particular, the extended shower holes 465 may be arranged along the front edge of the first receiving portion 54.

Therefore, the washing water falling from the extended shower hole 465 can fall onto the upper part of the front surface of the first receiving portion 54 or onto the surface forming the front surface of the first receiving portion 54. Furthermore, the washing water falling from the extended shower hole 465 flows along the front surface of the first receiving portion 54 and flows rearward along the inclined bottom surface of the first receiving portion 54. Therefore, the detergent adhering to the inner surface of the first receiving portion 54 can be washed off by the washing water falling from the extended shower hole 465.

Furthermore, the water used to wash the first receiving portion 54 can be discharged to the rear of the drawer 50 together with the detergent. Furthermore, the water and detergent discharged to the rear of the drawer 50 can be discharged into the tub 11 through the housing discharge port 321 and the front portion of the housing lower surface 32.

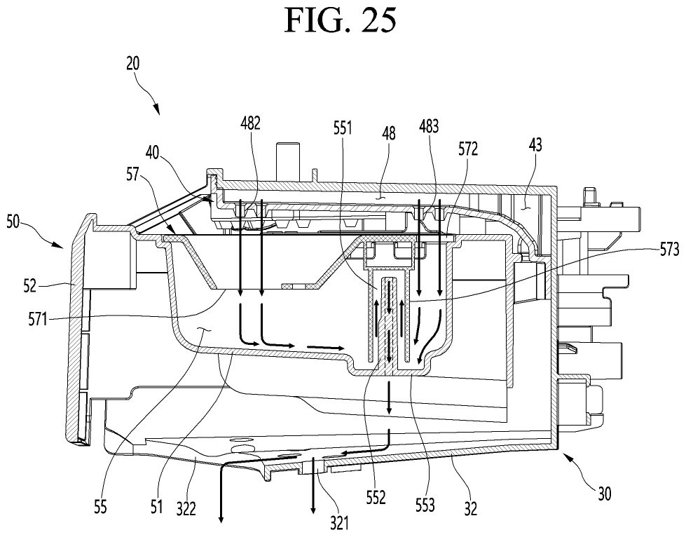

FIG. 25 is a drawing showing the washing water falling into the second receiving portion through the second shower hole formed in the flow path member.

Referring to FIGS. 22 and 25, the water entering the fourth discharge path 48 flows forward along the fourth discharge path 48 and can be supplied to the second receiving portion 55 through the second shower hole 481 formed in the fourth discharge path 48.

For example, liquid detergent can be contained in the second receiving portion 55, and after being diluted by the washing water supplied from the second shower hole 481, it can be discharged to the bottom of the housing 30 through the siphon boss 551.

In detail, a portion of the washing water flowing along the fourth discharge path 48 falls downward from the first front hole 482. At this time, the first front hole 482 passes through the first front cover hole 571 of the receiving portion cover 57 and falls toward the front of the second receiving portion 55. It can then be mixed with liquid detergent inside the second receiving portion 55.

Additionally, another portion of the washing water flowing along the fourth discharge path 48 falls downward through the first rear hole 483. At this time, the washing water falling through the first rear hole 483 passes through the first rear cover hole 572 of the receiving portion cover 57 and falls toward the rear of the second receiving portion 55.

The first rear hole 483, the first rear cover hole 572, and part of the siphon recess 553 may overlap in the vertical direction. Therefore, water falling from the first rear hole 483 can pass through the first rear cover hole 572 and fall directly into the siphon recess 553. Therefore, high-viscosity liquid detergent or solidified liquid detergent accumulated in the siphon recess 553 can be melted or crushed, thereby making it easier to discharge via the siphon effect.

The liquid detergent mixed with the water supplied to the second receiving portion 55 flows along the space between the siphon extension 573 and the siphon boss 551 from the siphon recess 553, enters the opening at the top of the siphon boss 551 and is discharged below the drawer 50. Furthermore, the liquid detergent mixed with water discharged below the drawer 50 can be discharged into the tub 11 through the housing discharge port 321 and the front end of the housing lower surface.

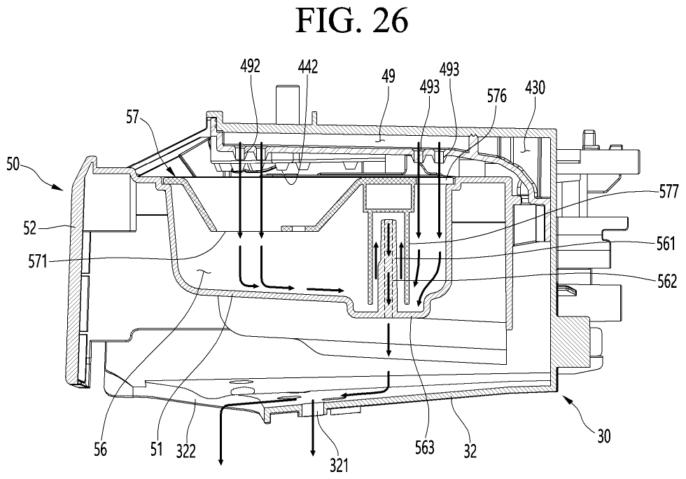

FIG. 26 is a drawing showing the washing water falling into the third receiving portion through the third shower hole of the flow path member.

Referring to FIGS. 22 and 26, the water entering the fifth discharge path 49 flows forward along the fifth discharge path 49 and can be supplied to the third receiving portion 56 through the third shower hole 491 formed in the fifth discharge path 49.

For example, the third receiving portion 56 may contain fabric softener, which can be diluted by the washing water supplied from the third shower hole 491 and discharged downward through the siphon boss 561.

In detail, a portion of the washing water flowing along the fifth discharge path 49 falls downward from the second front hole 492. At this time, the washing water falling from the second front hole 492 passes through the second front cover hole 575 of the receiving cover 57 and falls in front of the third receiving portion 56. The washing water falling into the third receiving portion 56 can be mixed with fabric softener.

The remaining portion of the washing water flowing along the fifth discharge path 49 falls downward through the second rear hole 493. At this time, the washing water falling from the second rear hole 493 passes through the second rear cover hole 576 of the receiving portion cover 57 and falls to the rear of the third receiving portion 56.

The second rear hole 493, the second rear cover hole 576, and part of the siphon recess 563 may overlap in the vertical direction. Therefore, water falling from the second rear hole 493 can pass through the second rear cover hole 576 and fall directly into the siphon recess 563. Therefore, high-viscosity liquid detergent or solidified liquid detergent accumulated in the siphon recess 563 can be melted or crushed, thereby making it easier to discharge via the siphon action.

The fabric softener mixed with the water supplied to the third receiving portion 56 flows along the space between the siphon extension 577 and the siphon boss 561 from the siphon recess 563, enters the opening at the top of the siphon boss 561, and can be discharged below the drawer 50. Furthermore, the fabric softener mixed with water discharged below the drawer 50 can be discharged into the tub 11 through the housing discharge port 321 and the front end of the housing lower surface 32.

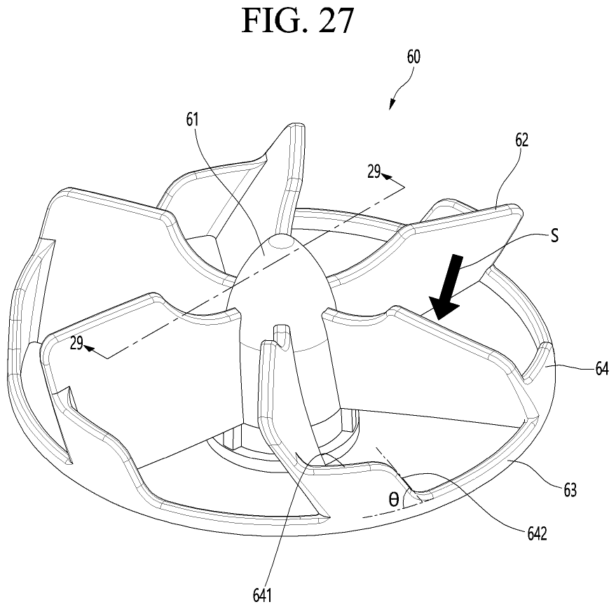

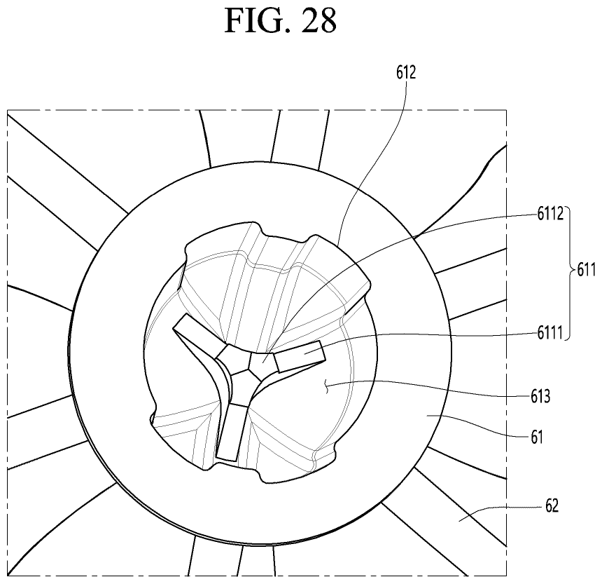

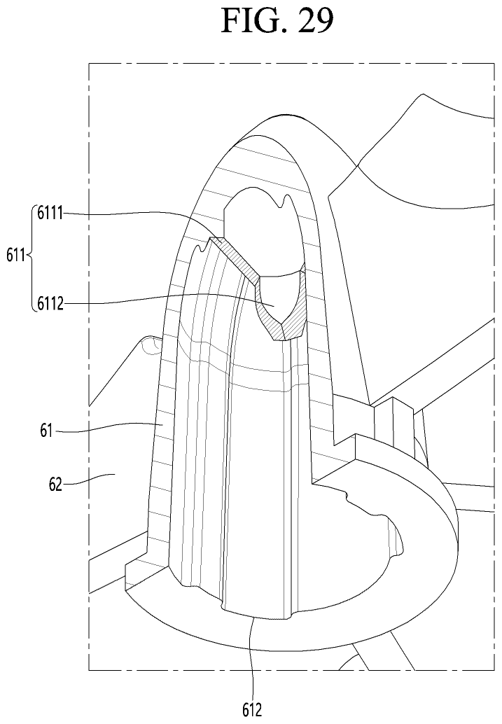

FIG. 27 is a perspective view of the mixing member according to an embodiment of the present invention, FIG. 28 is an enlarged perspective view of the rotation axis of the mixing member as viewed from below, and FIG. 29 is a cross-sectional view along the 29-29 line in FIG. 27.

Referring to FIGS. 27 to 29, the mixing member 60 constituting the detergent supply device 20 according to an embodiment of the present invention may be formed in a fan shape.

In detail, the mixing member 60 includes a rotation axis 61, a plurality of blades 62 extending radially from the outer surface of the rotation axis 61, and a ring 63 connecting the lower corners of the plurality of blades 62, as described above.

More specifically, the mixing member 60 may further include auxiliary wings 64 formed at the points where the blades 62 and the ring 63 meet.

The rotation axis 61 may be formed such that its diameter decreases gradually from the bottom to the top in a nonlinear manner, resulting in a smoothly rounded outer surface.

The blade 62 may be formed to slope in the direction of rotation of the blade 62 from the lower end to the upper end of the rotation axis. Therefore, the angle formed between the horizontal plane passing through the ring 63 and the radial end of the blade 62 may be less than 90 degrees.

With this structure, when washing water is sprayed toward the front of the blade 62 in the direction of the arrow S and hits it, the mixing member 60 rotates clockwise as shown in the drawing. Furthermore, the auxiliary wing 64 suppresses the phenomenon of powdered detergent in the space between the rotation shaft 61 and the ring 63 being scattered outside the mixing member 60.

Furthermore, since the ring 63 passes through the lower corner of the blade 62 in the radial direction, the lower corner of the blade 62 is not exposed in a sharp and pointed state. As a result, even if the user touches the blade 62 with their hands, the blade 62 will not cut them.

The ring 63 extends upward from the lower end of the blade 62 to a predetermined height, and the outer surface of the auxiliary wing 64 and the outer surface of the ring 63 can form a smooth single surface without any steps. That is, the rotational trajectory of the auxiliary wing 64 and the ring 63 can be formed as a cylindrical shape having a diameter corresponding to the height of the auxiliary wing 64 and the diameter of the ring 63. Furthermore, when the mixing member 60 is mounted on the rotating boss 541, the bottom surface of the ring 63 may be spaced apart from the bottom of the first receiving portion 54.

The auxiliary wing 64 may extend upward from the upper surface of the ring 63 to a predetermined height. For example, the auxiliary wing 64 may extend to a point corresponding to half of the length from the upper end to the lower end of the blade 62.

Additionally, the auxiliary wing 64 may extend circumferentially for a predetermined length from one of the adjacent blades 62 toward another. For example, the length of the lower end of the auxiliary wing 64 may be set to be less than half of the circumferential distance connecting the lower ends of two adjacent auxiliary wings 62.

Meanwhile, the auxiliary wing 64 includes an upper surface 641 and a side surface 642. The side surface 642 refers to the circumferential end of the auxiliary wing 64 and may be inclined at an angle in the same direction as the slope of the radial end of the blade 62. Furthermore, the corner where the upper and lower surfaces of the auxiliary wing 64 meet each other may be smoothly curved with a predetermined curvature. The angle θ formed between the side surface 642 and the ring 63 may be set to less than 90 degrees. At least one of the corner where the side of the auxiliary wing 64 and the upper surface of the ring 63 meet each other and the corner where the upper surface of the auxiliary wing 64 and the blade 62 meet each other may be formed with a rounded shape.

Meanwhile, a rotating boss insertion groove 613 is formed inside the rotation axis 61, and an axis support member 611 extends from an inner upper end of the rotation axis 61.

The axis support member 611 includes a support protrusion 6112 extending downward from the upper end of the rotation axis 61 for a predetermined length, and a support base 6111 extending in the form of a rib from the outer surface of the support protrusion 6112.

In detail, the lower end of the support base 6111 is formed to be pointed and rests on the upper surface of the rotating boss 541. Furthermore, the support base 611 includes a plurality of support ribs arranged at a predetermined angular interval in the circumferential direction, for example, three support ribs may be arranged at 120-degree intervals.

The inner surface of the rotation axis 61 may have a plurality of air gaps 612 formed by being recessed to a predetermined depth, and the plurality of air gaps 162 may be arranged at predetermined intervals in the circumferential direction. Furthermore, the air gaps 612 extend from the lower end to the upper end of the rotation axis 61, allowing air entering the rotating boss insertion groove 613 to flow smoothly out of the rotation axis 61 along the air gaps 612.

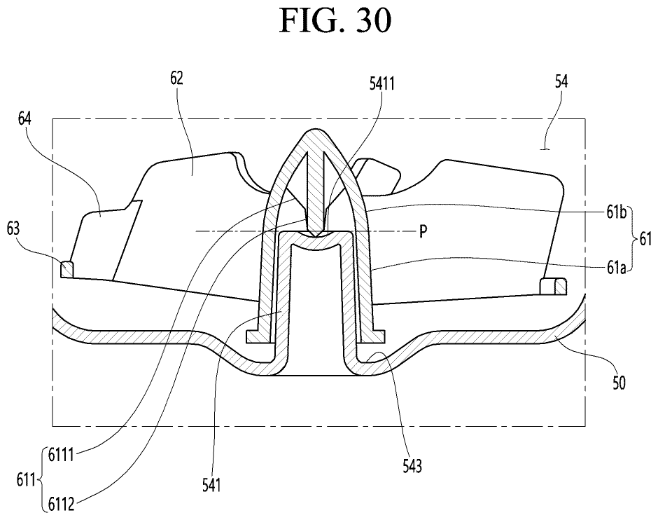

FIG. 30 is a cross-sectional view showing the rotating boss with the mixing member attached.

Referring to FIG. 30, the rotating boss 541 is inserted into the rotation axis 61 of the mixing member 60 as described above.

In detail, to minimize the friction between the inner surface of the rotation axis 61 and the rotating boss 541, the rotating boss 541 is formed as a cylindrical shape with a constant diameter, and the rotation axis 61 may be formed as a conical shape with an increasing diameter toward the lower end.

Alternatively, the rotating boss 541 may also be formed with a shape that the diameter increases toward the lower end, but is designed to be smaller than the inner diameter of the rotation axis 61 at the same horizontal plane, thereby minimizing the contact area between the rotating boss 541 and the rotation axis 61 and minimizing the friction force generated when the mixing member 60 rotates.

For example, the rotation axis 61 may include a first portion 61a whose inner diameter decreases gradually but linearly toward the upper side, and a second portion 61b formed at the upper end of the first portion 61a and having a parabolic shape with a pointed upper end. The outer shape of the second portion 61b may also be described as bullet-shaped. Alternatively, the inner diameter of the second portion 61b may be described as a conical shape that decreases non-linearly toward the top.

In this way, since the outer surface of the second portion 61b is formed to be rounded, the washing water falling toward the upper end of the rotation axis 61 can flow evenly across the entire surface of the second portion 61b. As a result, there is the advantage that the detergent adhering to the surface of the rotation axis 61 is thoroughly washed off. Furthermore, when the mixing member 60 rotates, there is an advantage in that resistance generated on the rotation axis 61 caused by air or powder detergent can be minimized.

Furthermore, the horizontal plane P passing through the point where the first portion 61a and the second portion 61b meet can be designed to pass through the upper surface of the rotating boss 541. With this structure, even if the rotation axis 61 tilts due to the pressure of the washing water, the upper edge of the rotating boss 541 can be made to contact only the first part 61a.

Additionally, a recess 5411 is formed on the upper surface of the rotating boss 541, and the support protrusion 6112 of the axis support member 611 is placed on the recess 5411. That is, the axis support member 611 is in point contact with the recess 5411, thereby minimizing the friction force generated between the axis support member 611 and the rotating boss 541 when the mixing member 60 rotates.

Furthermore, since the axis support member 611 is in point contact with the upper surface of the rotating boss 541, even if the mixing member 60 tilts due to the pressure of the washing water acting on the blade 62, it can immediately return to its original state.

Furthermore, the lower end of the rotation axis 61 is positioned on the drainage groove 543 formed on the edge of the rotating boss 541, but is designed not to come into contact with the drainage groove 543.

Furthermore, the lower end of the blade 62 is designed to be spaced apart from the lower end of the rotation axis 61 in an upward direction, so that the lower end of the blade 62 does not interfere with the bottom of the first receiving portion 54.

What is claimed is:

1. A laundry machine, comprising:
a cabinet;
a tub rotatably disposed within the cabinet; and
a detergent supply device provided in the cabinet for supplying detergent to the tub,
wherein the detergent supply device comprises:
a housing fixedly mounted to the cabinet and connected to a water supply device;
a drawer withdrawbly mounted to the housing, and including a receiving portion recessed to accommodate detergent and a rotating boss extending upward from a bottom of the receiving portion;
a mixing member rotatably disposed in the receiving portion to mix the detergent inside the receiving portion; and
a flow path member that is connected to the housing at a position above the drawer and forms a flow path for supplying washing water from the water supply device to the drawer,
wherein the mixing member includes:
a rotation axis with a diameter that increases toward the bottom, into which the rotating boss is inserted; and
a plurality of blades extending radially from an outer surface of the rotation axis.

2. The laundry machine according to claim 1, wherein the mixing member further includes an axis support member extending from an inner upper end of the rotation axis,
and wherein the axis support member is placed on an upper surface of the rotating boss.

3. The laundry machine according to claim 2, the axis support member includes:
a support protrusion extending downward from the inner upper end of the rotation axis for a predetermined length; and
a plurality of support bases extending in a rib shape from an outer surface of the support protrusion.

4. The laundry machine according to claim 3, wherein a lower end of each of the plurality of support bases extends to a point spaced upward from a lower end of the support protrusion.

5. The laundry machine according to claim 3, wherein an end of the support protrusion is formed to be pointed,
and wherein the upper surface of the rotating boss includes a recessed portion where the end of the support protrusion is seated.

6. The laundry machine according to claim 1, wherein a diameter of the rotating boss is constant or increases toward the lower end.

7. The laundry machine according to claim 6, wherein an inner diameter of the rotation axis decreases toward the upper end.

8. The laundry machine according to claim 7, wherein the rotation axis includes:
a first portion of which an inner diameter decreases linearly from the bottom toward the top; and
a second portion formed at an upper end of the first portion, and having a longitudinal section that forms a parabolic shape.

9. The laundry machine according to claim 8, wherein the upper surface of the rotating boss is coplanar with a horizontal plane passing through the point where the first portion and the second portion meet.

10. The laundry machine according to claim 6, wherein a drainage groove is formed on a bottom of the receiving portion corresponding to an edge of the rotating boss,
and wherein a lower end of the rotation axis is positioned in the drainage groove and spaced apart from a bottom of the drainage groove.

11. The laundry machine according to claim 1, wherein the mixing member further includes a ring connecting lower ends of the radial ends of the plurality of blades.

12. The laundry machine according to claim 11, wherein the mixing member further includes auxiliary wings connecting the radial ends of each blade to an upper surface of the ring.

13. The laundry machine according to claim 12, wherein the auxiliary wing has a predetermined height and extends along the ring for a predetermined length.

14. The laundry machine according to claim 13, wherein side edges of the blades and the auxiliary wings are formed to incline in the rotational direction of the blades from the bottom to the top.

15. The laundry machine according to claim 14, wherein at least one of the corner where the upper end of the auxiliary blade and the blade meet, the corner where the upper and side ends of the auxiliary blade meet, or the corner where the side end of the auxiliary blade and the ring meet is formed in a rounded shape.
